(19) United States
(12) Patent Application Publication
(10) Pub. No.: US 2026/0080615 A1
(43) Pub. Date: Mar. 19, 2026

(54) SYSTEMS AND METHODS FOR LOCALIZED COORDINATION AND IMAGE CAPTURE FOR MODELING AN ENVIRONMENT

(71) Applicant: Matterport, Inc., Sunnyvale, CA (US)

(72) Inventors: Abhijit Limaye, Sunnyvale, CA (US); Darren Ashby, Sunnyvale, CA (US); Japjit Tulsi, Sunnyvale, CA (US)

(73) Assignee: Matterport, Inc., Sunnyvale, CA (US)

(21) Appl. No.: 18/957,446

(22) Filed: Nov. 22, 2024

Related U.S. Application Data
(60) Provisional application No. 63/695,787, filed on Sep. 17, 2024.

(51) Int. Cl. G06T 17/00; G01S 5/08; G06T 19/00; H01Q 5/25

(52) U.S. Cl. CPC G06T 17/00; G01S 5/08; G06T 19/003; H01Q 5/25

(57) ABSTRACT

An example method may include receiving a set of images associated with a real-world environment, receiving first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images, and generating a navigational model of the real-world environment using the first positional measurements associated with different subsets of the set of images to increase accuracy of the model of the real-world environment.

### RELATED APPLICATION

This application claims the priority benefit of U.S. Provisional Ser. No. 63/695,787, filed on Sep. 17, 2024, entitled “Systems and Methods for Localized Coordination and Image Capture for Modeling an Environment,” which is incorporated by reference herein.

### FIELD OF THE INVENTION(S)

Embodiments of the present invention(s) are generally related to navigational model generation of a real-world environment, and in particular to systems for localized coordination and image capture for modeling a real-world environment.

### BACKGROUND

Generating digital models based on 2D images is traditional expensive and often requires complex hardware. Images of an environment must be captured and used to create the digital model. Stitching the images, however, tends to be complex, time consuming, and prone to alignment and/or orientation error leading to inaccuracies and artifacts in the digital model.

While some users may attempt to use GPS for location assistance, GPS is often unavailable inside and may not have enough precision to assist with location determination of image capture positions.

### SUMMARY

In various embodiments, the techniques described herein relate to a non-transitory computer-readable medium including executable instructions, the executable instructions being executable by one or more processors to perform a method, the method including: receiving a set of images associated with a real-world environment, receiving first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images, and generating a navigational model of the real-world environment using the first positional measurements associated with different subsets of the set of images to increase accuracy of the model of the real-world environment.

The one or more anchor systems may provide UWB signals as the first positioning signals. In some embodiments, the one or more anchor systems include at least three anchor systems that provide the first positioning signals. The set of images may include a second subset of images captured by the image capture device at a second location, the second subset of images being taken by the image capture device of the real-world environment, the first subset of images being a different portion of the real-world environment relative to the second subset of images, and generating the navigational model comprises using the first positional measurements associated with both the first subset of images and the second subset of images. In various embodiments, receiving second positional measurements generated at or near a time that the second subset of the set of images are captured by the image capture device at the second location, the second positional measurements indicating a second position relative to positioning signals provided by the one or more anchor systems.

In some embodiments, the positional measurements are based on positioning signals received from the image captured device by the one or more anchor systems, each of the one or more anchor system determining an angle of arrival based on the positioning signals. For each anchor system of the one or more anchor systems, the angle of arrival may be based on a position of a plurality of antennas that receive the positioning signals, each anchor system including a different plurality of antennas in a fixed position relative to each other for thar particular anchor system. In some embodiments, the positional measurements are based on positioning signals received from the image captured device by the one or more anchor systems, each of the one or more anchor system determining a vector directed to the image capture device based on the positioning signals. The positional measurements may be based on positioning signals received from the anchor systems by the image capture device, each of the one or more anchor system determining an angle of arrival based on the positioning signals.

An example method comprises receiving a set of images associated with a real-world environment, receiving first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images, and generating a navigational model of the real-world environment using the first positional measurements associated with different subsets of the set of images to increase accuracy of the model of the real-world environment.

An example system may comprise at least one processor and memory. The memory may contain instructions to control the at least one processor to receive a set of images associated with a real-world environment, receive first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images, and generate a navigational model of the real-world environment using the first positional measurements associated with different subsets of the set of images to increase accuracy of the model of the real-world environment.

### BRIEF DESCRIPTION OF THE DRAWINGS

FIG. 1 depicts placement of four anchor systems in an environment in some embodiments

FIG. 2 depicts an example anchor system in some embodiments

FIG. 3A depicts an example anchor system in some embodiments.

FIG. 3B and FIG. 3C depict other examples of the anchor system in some embodiments.

FIG. 4 is a flowchart for determining a position of an image capture device utilizing one or more anchor system(s) in some embodiments.

FIG. 5 is a flowchart for determining position of an image capture device utilizing one or more anchor system(s) and a smartphone in some embodiments.

FIG. 6 is a flowchart for tracking movement of an image capture device utilizing one or more anchor system(s) in some embodiments.

FIG. 7 is a flowchart for team scanning using any number of image capture devices utilizing one or more anchor system(s) in some embodiments.

FIG. 8 is a flowchart for moving one or more anchor system(s) in some embodiments.

FIG. 9 is a flowchart for identifying positions of difficult surfaces and materials utilizing anchor systems in some embodiments.

FIG. 10 is a flowchart depicting a method for tracking movement and/or position of an image capture device in some embodiments.

FIG. 11 is a box diagram example of a sensor component in some embodiments.

FIG. 12 depicts an example sensor component in some embodiments.

FIG. 13 depicts another sensor component coupled to a digital capture device in some embodiments.

FIG. 14 depicts another sensor component coupled to a digital capture device in some embodiments.

Throughout the drawings, like reference numerals will be understood to refer to like parts, components, and structures.

### DETAILED DESCRIPTION

It will be appreciated that creation of a model of a real-world environment (e.g., a building, house, factory, and the like) may include images (e.g., 2D images) captured by one or more image capture devices (e.g., cameras). In various embodiments, depth information may also be captured to assist in creation of the model and/or generate a mesh. The model may be used for navigation of the model (e.g., a 3D model rendered on a digital device such as a computer, smartphone, or the like).

In order to stitch images captured by the image capture device and/or create models based on the images, position and orientation of the images (e.g., based on the position and/or orientation of the image capture device at the time one or more image(s) were taken) may be taken into account for an accurate representation in the model.

In various embodiments, anchor systems may be utilized to assist in determining position of one or more digital capture devices when the image capture device(s) capture images of the real-world environment. An anchor system is any digital device with one or more antennas capable of transmitting energy that may be used to determine or assist in determining position. A digital device is any device with a processor and memory. Any number of anchor systems may be utilized (e.g., three to triangulate a position of an image capture device) to assist in determining the location of one or more image capture device(s).

In one example, an anchor system may utilize Ultra-Wideband (UWB). UWB is a wireless communication protocol that uses radio waves that may operate at very high frequencies, allowing it to carry a large amount of data over a short distance while consuming low power. UWB may allow for high accuracy and precision down to the centimeter level, which is significantly more precise than other technologies like Wi-Fi or Bluetooth. This high precision is due to its use of short, wideband pulses that can resolve the time of arrival and the angle of arrival of signals with high accuracy. UWB signals may also be capable of penetrating through obstacles such as walls and doors more effectively than narrower band technologies. Moreover, UWB systems are highly resistant to multipath interference, where signals bounce off surfaces before reaching the receiver. This makes UWB particularly effective in complex environments.

While anchor systems described herein utilize UWB, it will be appreciated that any protocol or antenna may be used as long as the signals generated and/or received by the anchor system(s) may be utilized to determine a position of one or more image capture device(s) before or at the time of image capture.

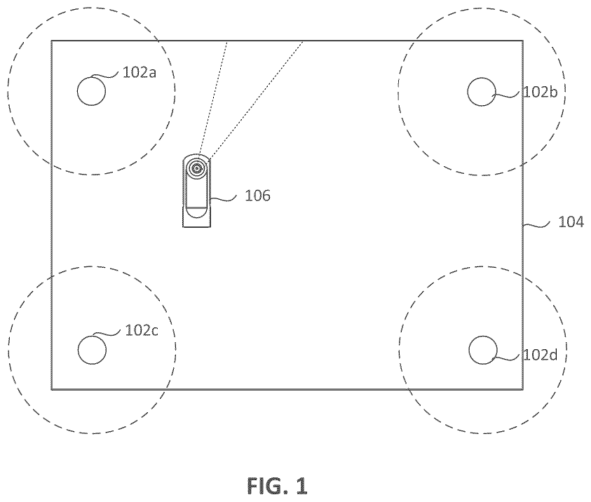

FIG. 1 depicts placement of four anchor systems in an environment in some embodiments. FIG. 1 depicts anchor systems 102a-d in the environment 104. The environment 104 may be the inside of a building, house, factory, or the like. In some embodiments, the environment 104 is outside or a combination of inside and outside a facility.

FIG. 1 further depicts an image capture device 106 (e.g., depicted as a Matterport 360 camera). It will be appreciated that the image capture device 106 may be any camera, smartphone, or the like. In some embodiments, the image capture device 106 captures images and depth data of the surrounding environment 104.

In various embodiments, the image capture device 106 and/or the anchor systems 102(a)-(d) may determine or assist in determining the location of the image capture device 106 relative to the anchor systems 102 (e.g., utilizing triangulation based on a strength of signal from the image capture device 106 to any number of the anchor systems 102(a)-(d)). In some embodiments, the image capture device 106 and/or the anchor systems 102 may determine or assist in determining the orientation of the image capture device 106 relative to the anchor systems 102. The orientation may assist in determining the field of view of the image capture device 106 (e.g., based on particular parameters of the image capture device 106 such as direction of the lens relative to the orientation of the image capture device, vertical and horizontal width of the field of view of a camera, and/or the like). In some embodiments, the orientation may assist in determining the coverage and direction of a depth device (e.g., LiDAR) of the image capture device 106 or in addition to the image capture device 106.

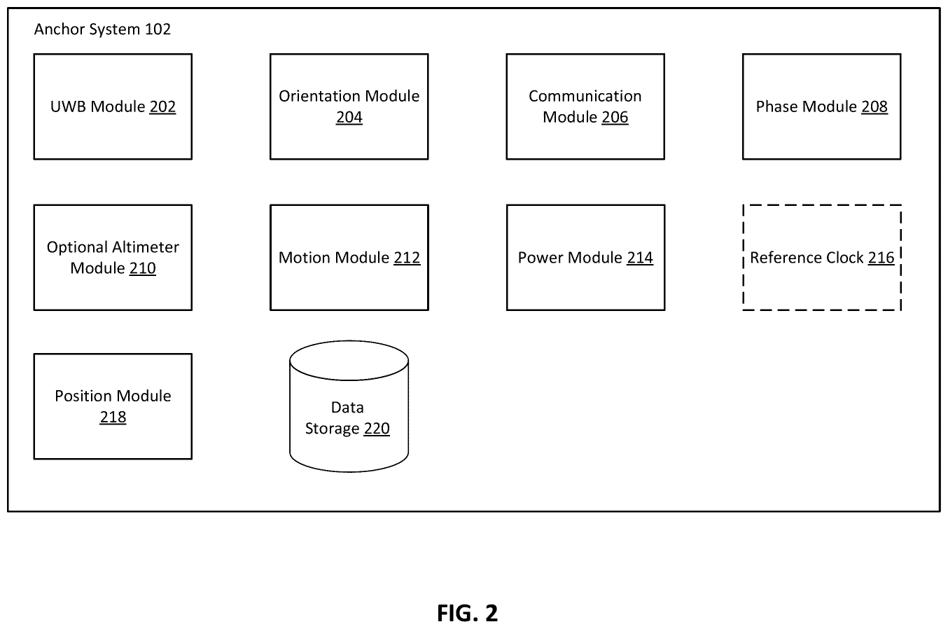

FIG. 2 depicts an example anchor system 102 in some embodiments. The anchor system 102 may include a UWB module 202, an orientation module 204, a communication module 206, a phase module 208, an optional altimeter module 210, a motion module 212, a power module 214, an optional reference clock 216, a position module 218, and a data storage 220. The UWB module 202 provides or emits a UWB signal. In some embodiments, the anchor system 102 may include any number of antennas (e.g., spaced about the anchor system 102) for transmitting and/or receiving UWB signals. As discussed herein, while examples are discussed herein as utilizing UWB signals, it will be appreciated that the anchor system 102 may utilize any protocol or combination of protocols (e.g., Wi-Fi, RF, UWB, and/or the like).

In some embodiments, the anchor system 102 includes a number of antennas (e.g., three or more) positioned at different points or surfaces of the anchor system 102. The anchor system 102 may utilize spatial diversity based on positions of the antennas and signal strength to determine AoA (discussed herein) and/or other positional information (e.g., degree) of digital devices (e.g., through positioning signals from other anchor systems 102 and/or image capture devices 106).

The optional orientation module 204 may determine the orientation of the anchor system 102. In some embodiments, the anchor system 102 does not have an orientation module 204 and the orientation of the anchor system 102 is not determined. The optional orientation module 204 may assist in determining the orientation of the anchor system 102. The orientation of the anchor system 102 may be shared with other anchor systems 102, an image capture device 106, and/or an other digital device (e.g., a smart phone). The orientation of the anchor system 102 may assist, in some embodiments, with determining the orientation of one or more image capture device(s) 106.

In some embodiments, the orientation module 204 receives positioning signals from any number of sources (e.g., other anchor systems 102). In some embodiments, based on the antenna(s) receiving the positioning signal(s) (e.g., utilizing spatial diversity from the different antennas at fixed positions relative to the anchor system 102) and signal strength, the orientation module 204 may determine an orientation of the anchor system 102 relative to the other sources (e.g., other anchor systems 102).

The communication module 206 may provide communication between the anchor system 102 and any number of other anchor system(s) 102, any number of image capture device(s) 106, and/or any number of other digital devices (e.g., smartphones). In some embodiments, the communication module 206 is optional (e.g., the anchor system only provides the positioning signal (e.g., UWB signal) and optionally orientation information. The positioning signal may be utilized by a smart phone and/or image capture device 106 to determine the position or assist in determining the position and/or orientation of the image capture device 106 prior to or at the time of image capture. The position of the image capture device 106 at the time images are captured may be associated with those captured images to assist in model generation.

The communication module 206 may, in some embodiments, allow any number of anchor system 102 to communicate with each other. In some embodiments, the communication module 206 may enable communications over Bluetooth, Zigbee, Wi-Fi, and/or any protocol.

Although not depicted in FIG. 2, it will be appreciated that the anchor system 102 may include a mount (e.g., a bracket or socket) or be coupled to a mount (e.g., a camera mount) to elevate the anchor system 102 above the floor and/or to a desired height. The mount may be configured to mount the anchor system 102 on a member of system (e.g., pole, tripod, stabilization system, drone, robot, or the like). In some embodiments, the anchor system 102 may include a balance system configured to stabilize and balance a position when mounted on a platform, pole, tripod, or the like.

The optional phase module 208 may be utilized to direct communication and/or positioning signals to a particular area (e.g., out towards the middle or sides of the environment 104). In some embodiments, the phase module 208 may direct positioning signals automatically (e.g., towards an image capture device 106 or a smart phone) or may be performed manually (e.g., by a user manually moving one or more physical antennas of the anchor system 102, orienting the anchor system 102, and/or controlling software that communicates with the anchor system 102).

The optional altimeter module 210 may assist in determining the altitude of the anchor system 102. In various embodiments, measurements of the height of a position may assist in determining the location of one or more image capture device(s) 106. In some embodiments, an image capture device 106 may be moved relative to an anchor system 102 and the optional altimeter module 210 may assist in determining if the image capture device 106 changed height (e.g., the image capture device 106 was moved upstairs to capture another floor, the image capture device 106 is mounted on a telescoping pole, the image capture device 106 is mounted on a drone, and/or the like).

The motion module 212 may assist in determining if an anchor system 102 is moved or is in motion. In various embodiments, the anchor system 102 may determine its location relative to one or more other anchor system(s) 102 (e.g., utilizing the positioning signals of the other anchor system(s) 102). If the anchor system 102 is moved, the motion module 212 may assist in determining when the anchor system 102 is in motion and/or becomes stationary. While in motion, in some embodiments, the anchor system 102 (or the image capture device 106 or the smart phone) may determine the location of the anchor system 102 while in motion (e.g., relative to the other anchor system(s) 102). In various embodiments, once the anchor system 102 becomes stationary again, the anchor system 102 may determine its new position, altitude, and the like relative to the other anchor system(s) 102 and relative to where the anchor system 102 used to be (e.g., thereby extending the localized coordinate reference system that may be used by one or more image capture device 106 to determine position).

In some embodiments, the motion module 212 may track the position of one or more image capture device(s) 106 when they are in motion and/or track when the one or more image capture device(s) 106 become stationary after moving.

The power module 214 is any component or device that may provide power to the anchor system 102. In some embodiments, the power module 214 may include a battery (e.g., an alkaline battery, a lithium battery, a polymer battery, or the like). In various embodiments, the power module 214 may be powered over a cable (e.g., receiving power via an outlet or other power source).

The optional reference clock 216 may generate or receive clock signals. In some embodiments, the anchor system 102 may generate a time stamp based on the clock signals of the reference clock 216 and associate them with position information discussed herein. The timestamp may be associated with position information (e.g., AoA, distance, and/or degree) provided to a digital device (e.g., smart phone, laptop, cloud based device executing a platform, and/or the like).

In some embodiments, the optional reference clock 216 may synchronize with one or more other reference clocks. For example, the optional reference clock 216 may synchronize with another anchor system 102 (e.g., one of the anchor system 102 being a master), one or more image capture devices 106, a smart phone (e.g., via an app on the smartphone that communicates with the position module 218), and/or a reference clock signal received from a remote device (e.g., on a platform). In other embodiments, the optional reference clock 216 is not synchronized.

The position module 218 may determine positioning information (i.e., position information) based on a positioning signal received from an image capture device 106 and/or an anchor system 102. The positioning signal and, optionally a timestamp at the time the positioning information was generated may be provided to another digital device.

In some embodiments, each anchor system 102 may determine the angle of arrival and distance for one or more other anchor system 102 and/or image capture device 106 positioned in the environment. An Angle of Arrival (AoA) is a method used in wireless communications to determine the direction from which a received signal was transmitted. The anchor system 102 may have different antenna elements positioned at different positions within the anchor system (e.g., at different corners or positions of the anchor system 102). The position module 218 may determine or estimate the vector and degree from the signal received from one or more of the different antennas.

It will be appreciated that, in some embodiments, the AoA is not determined but the position module 218 determines the vector and degree. Although AoA is discussed in many examples herein, it will be appreciated that, in some embodiments, the position module 218 does not determine the AoA but only provides the vector(s) and/or degree(s) (i.e., the raw data of measurements). As such, where providing, receiving, or using AoA is indicated, it will be appreciated that the discussion herein may only be the raw data of measurements and not the AoA.

The anchor system 102 may utilize AoA (or only the vector and degree measurements) to estimate the direction of the incoming signal by measuring the phase or time difference (e.g., based on the optional reference clock 216) as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the position module 218 may utilize the AoA estimation and the strength of signal (e.g., utilizing a Received Signal Strength Indicator (RSSI) also determined by the position module 218) to determine AoA and distance between the anchor system 102 and another anchor system 102 or image capture device 106. In some embodiments, the anchor system 102 may additionally use a time of arrival (ToA) to further determine the direction and distance of another anchor system 102 or image capture device 106.

The optional data storage 220 is any data storage and may include firmware to operate the anchor system 102, store positional information of the anchor system 102 relative to other anchor system(s) 102, store positional information (e.g., AoA, distance, RSSI, timestamps, and the like) of one or more image capture device(s) 106, store orientation information of the anchor system 102, store orientation information of one or more image capture device(s) 106, store tracking data of movement or new positions of the anchor system 102 and/or the image capture device(s) 102, height information, and/or the like.

In various embodiments, the anchor system 102 may include a GPS device (e.g., a GPS module) capable of determining a location relative to a GPS signal. In some embodiments, if satellite information is unavailable (e.g., blocked), then the anchor system 102 may not utilize GPS coordinates (e.g., the local coordinate system that may be established by one or more anchor system(s)) 102 may not be associated with geocoordinates from the GPS device. If there is a GPS device in one or more anchor systems (102) or the image capture device 106, the local coordinate system established by the one or more anchor system(s)) 102 may be associated with geocoordinates from the GPS device.

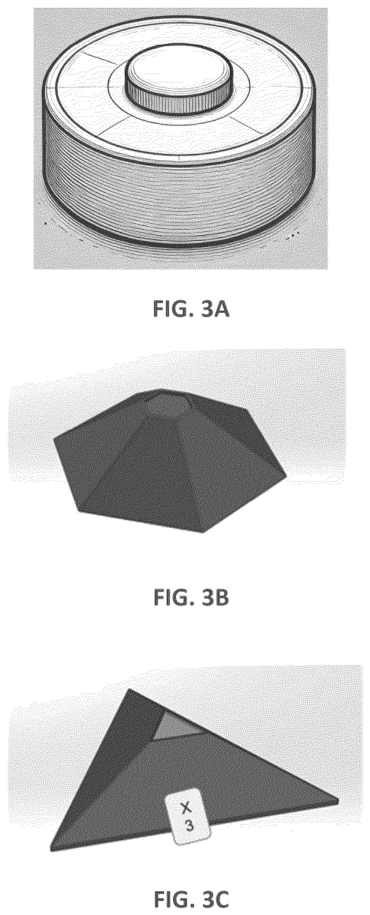

FIG. 3A depicts an example anchor system 102 in some embodiments. Although the anchor system 102 depicted in FIG. 3A is radial, it will be appreciated that the anchor system 102 may be any shape or design.

FIG. 3B and FIG. 3C depicts other examples of the anchor system 102 in some embodiments. In FIG. 3B, the anchor system 102 has six sides, each side including an antenna element. In FIG. 3C, the anchor system 102 includes three sides, each side including an antenna element. The spatial diversity and fixed placement of the antennas may assist in determining position using a received positioning signal by the antenna(s). It will be appreciated that the anchor system 102 may have any shape and any number of antennas.

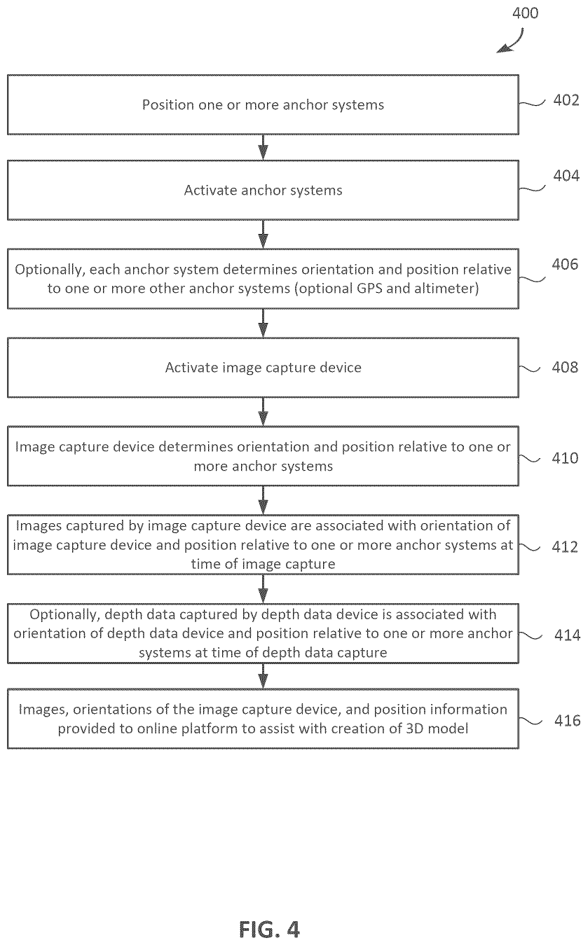

FIG. 4 is a flowchart 400 for determining a position of an image capture device 106 utilizing one or more anchor system(s) 102 in some embodiments. In step 402, one or more anchor system(s) 102 are positioned in an environment. As depicted in FIG. 1, anchor system(s) 102 may be positioned in corners of an environment or in any location. There may one or more anchor system(s) 102 positioned in an environment. It will be appreciated that positioning three or more anchor systems 102 may allow for improvements in positional accuracy of the image capture device 106.

In step 404, each anchor system 102 is activated. In various embodiments, each anchor system 102 may include a switch or button to activate the system.

In optional step 406, each anchor system 102 may determine its position relative to one or more of the other anchor systems 102. For example, an anchor system 102 may determine the strength and/or position of a positioning signal (e.g., UWB) of other anchor systems 102 to determine or assist in determining its own position. In various embodiments, the anchor system 102 may utilize the UWB module 202 to provide and receive UWB signals. The UWB module 202 may also determine position of the anchor system 102 based on received UWB signals. In some embodiments, one or more of the anchor system(s) 102 may determine its orientation (e.g., via the orientation module). In various embodiments, the orientation module 204 may determine orientation manually by a user, through determining magnetic north, and/or any number of other measurements).

As discussed herein regarding FIG. 2, in some embodiments, each anchor system 102 may determine the angle of arrival and distance for one or more other anchor system(s) 102 positioned in the environment. The anchor system 102 may have different antenna elements positioned at different positions within the anchor system (e.g., at different corners or positions of the anchor system 102). The position module 218 may determine or estimate the vector and degree from the signal received from one or more of the different antennas.

The anchor system 102 may utilize AoA (or only the vector and degree measurements) to estimate the direction of the incoming signal by measuring the phase or time difference (e.g., based on the optional reference clock 216) as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the position module 218 may utilize the AoA estimation and the strength of signal (e.g., utilizing a Received Signal Strength Indicator (RSSI) also determined by the position module 218) to determine AoA and distance between the anchor system 102 and another anchor system 102. In some embodiments, the anchor system 102 may additionally use a time of arrival (ToA) to further determine the direction and distance of another anchor system 102 or image capture device 106.

In step 408, a user may activate the image capture device 106. In step 410, the image capture device 106 determines its orientation and position relative to one or more of the activated anchor system(s) 102. In various embodiments, the image capture device 106 is configured to receive or detect positioning signals (e.g., UWB signals) from the one or more anchor system(s) 102. Utilizing strength of signal and triangulation, the image capture device 106 may determine its relative position (see discussion with regard to FIG. 2). Alternately, the image capture device 106 may determine the strength and/or orientation of the positioning signals and provide those measurements as well as the time of the measurements to another digital device (e.g., smart phone, anchor system 102, and/or online platform) to associate location and images.

As discussed herein, in some embodiments, each anchor system 102 may determine the angle of arrival and distance of the image capture device 106 positioned in the environment. The image capture device 106 or another digital device (e.g., sensor component discussed herein or smartphone) may be configured to provide a positioning signal when at the scan point. The anchor system 102 may have different antenna elements positioned at different positions within the anchor system (e.g., at different corners or positions of the anchor system 102). The position module 218 may determine or estimate the vector and degree from the positioning signal received from one or more of the different antennas.

The anchor system 102 may utilize AoA (or only the vector and degree measurements) to estimate the direction of the incoming positioning signal by measuring the phase or time difference (e.g., based on the optional reference clock 216) as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the position module 218 may utilize the AoA estimation and the strength of signal (e.g., utilizing a Received Signal Strength Indicator (RSSI) also determined by the position module 218) to determine AoA and distance between the anchor system 102 and the image capture device 106. In some embodiments, the anchor system 102 may additionally use a time of arrival (ToA) to further determine the direction and distance of the image capture device 106.

It will be appreciated that the position information from the one or more anchor system(s) 102 may be utilized to create a local coordinate reference system to enable determination of a position of the image capture device 106 at the time images are captured. In some embodiments, additionally, the positioning signals from the one or more anchor system(s) 102 may be utilized to create a local coordinate reference system to enable determination of an orientation of the image capture device 106 at the time images are captured.

In some embodiments, the image capture device 106 may provide a positioning signal to any number of anchor systems 102. Each anchor system 102 may determine the AoA, distance, vector, and timestamp of one or more of these at the time of generation. The anchor system 102 may provide the image capture device 106 the AoA, distance, and optional timestamp to the image capture device 106 which may associate the AoA, distance, and/or optional timestamp to any captured images and/or measurements captured at that position. In some embodiments, the image capture device 106 may generate metadata for images and/or measurements that includes the positional information (e.g., AoA, distance, and/or optional timestamp). The metadata may be used to assist (e.g., in addition to orientation) in stitching, aligning, and/or orienting the images to create a digital model of the environment. It will be appreciated that the positional information may greatly improve accuracy and reduce artifacts when creating the digital model.

In some embodiments, the timestamp is optional. In one example, the image capture device 106 may generate metadata including only the AoA and distances provided by the one or more anchor system(s) 102 at or near the time of generation of the images and/or measurements.

In various embodiments, the positional information, images, and/or measurements are provided to another digital device that may associate and/or generate metadata for the images and/or measurements including the positional information. In some embodiments, the other digital device may utilize timestamps to associate when images and/or measurements were captured with the timestamp indicated by the positional information.

In some embodiments, the orientation of the image capture device 106 may determine based on the positioning signals of the anchor system(s) 102. In various embodiments, the anchor system(s) 102 may provide additional signals to assist in determining orientation of the image capture device 106. In another example, a smart phone or other digital device may be placed proximate to and orientated in the same direction (e.g., the camera of the smart phone may be directed to the same direction as the lens of the image capture device 106) and the orientation of the smart phone used to determine orientation of the image capture device 106.

In step 412, images captured by the image capture device 106 are associated with orientation of the image capture device 106 and position of the image capture device 106 at the time of capture. In various embodiments, the image capture device 106 associates particular images with the measurements of the strength of any number of positioning signals of any number of anchor system(s) 102 before image capture, at the time of image capture or after image capture. The associated information (e.g., metadata or separate data stream) may be provided to a smart phone (e.g., via a Wi-Fi, Bluetooth, or other protocol) and/or an online platform (e.g., a third party server over the Internet).

In some embodiments, the image capture device 106 may periodically or constantly measure the strength of positioning signal(s) from any number of anchor system(s) 102 and provide the measurements along with images or image identifiers to another digital device (e.g., smart phone or another anchor system) in real time. The other digital device may associate the denote the images with the measurements or a determined location (and/or orientation) of the image capture device 106 at or near the time the image(s) were captured.

In optional step 414, depth data captured by depth data device is associated with orientation of depth data device and position relative to one or more anchor systems at time of depth data capture. The depth data device may be any device capable of determining depth (e.g., LiDAR, laser, and/or the like). In some embodiments, the depth data device is separate from the image capture device 106 (e.g., a separate device or accessory that may be coupled to the image capture device 106 as discussed herein). In various embodiments, the depth data device is a part of the image capture device 106 (e.g., the image capture device 106 may capture both images and depth data such as the Matterport Pro3).

It will be appreciated that the depth data may be associated with the position or measurements of the position of the anchor system 102 in a manner similar to that described with regard to images.

For example, depth data captured by the image capture device 106 or a separate depth device may be associated with orientation of the age capture device 106 or a separate depth device and position of the image capture device 106 or a separate depth device at the time of capture. In various embodiments, the image capture device 106 or a separate depth device associates particular depth data with the measurements of the strength of any number of positioning signals of any number of anchor system(s) 102 before depth data capture, at the time of depth data capture or after depth data capture. The associated information (e.g., metadata or separate data stream) may be provided to a smart phone (e.g., via a Wi-Fi, Bluetooth, or other protocol) and/or an online platform (e.g., a third party server over the Internet).

In some embodiments, the image capture device 106 or a separate depth device may periodically or constantly measure the strength of positioning signal(s) from any number of anchor system(s) 102 and provide the measurements along with depth data or depth data identifiers to another digital device (e.g., smart phone or another anchor system) in real time. The other digital device may associate the denote the depth data with the measurements or a determined location (and/or orientation) of the image capture device 106 or a separate depth device at or near the time the depth data was captured.

In step 416, the image capture device 106 or a separate depth device may provide images, orientation of the image capture device 106 at or near the time of image capture, position of the image capture device 106 at or near the time of image capture (relative to the positioning signals from the one or more anchor systems 102), depth data, orientation of the image capture device 106 or depth device at or near the time of depth data capture, and/or position of the image capture device 106 or depth device at or near the time of depth data capture (relative to the positioning signals from the one or more anchor systems 102) to an online platform (e.g., server over the Internet) or other device (e.g., smart phone or laptop). In some embodiments, the smart phone or laptop may provide all or some of the information (preprocessed or not processed) to the online platform.

The images, depth data, indications (e.g., measurements) of position of the image capture device 106 when one or more images are captured, orientation indications (e.g., measurements) of the image capture device 106 when one or more images are captured, indications(e.g., measurements) of position of the image capture device 106 or depth device when depth data is captured, orientation indications (e.g., measurements) of the image capture device 106 or depth device when depth data is captured, may be used to generate model of the environment (e.g., improvement dimensional and positional accuracy).

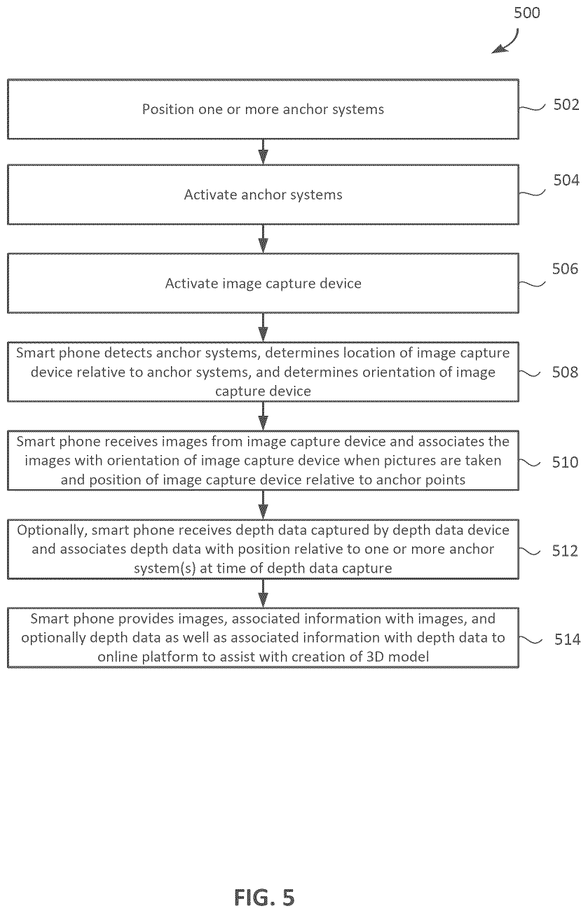

FIG. 5 is a flowchart 500 for determining position of an image capture device 106 utilizing one or more anchor system(s) 102 and a smartphone in some embodiments. In step 502, one or more anchor system(s) 102 are positioned in an environment. As depicted in FIG. 1, anchor system(s) 102 may be positioned in corners of an environment or in any location. There may be one or more anchor system(s) 102 positioned in an environment. Although a smartphone is described herein, any digital device may be utilized (e.g., laptop, computer, smart tablet, or the like).

In step 504, each anchor system 102 is activated. In various embodiments, each anchor system 102 may include a switch or button to activate the system. In step 506, a user may activate the image capture device 106. In step 510, the smart phone detects anchor systems 102 and determines a location of image capture device 106 relative to anchor system(s), and optionally determines orientation of image capture device 106 (e.g., based on information from the image capture device 106, positioning information from the anchor system(s) 102, orientation of the smartphone, or the like).

In some embodiments, the image capture device 106 provides measurements of the strength of any number of the positioning signals from any number of the anchor systems 102 to the smart phone (e.g., in real time). The smart phone may receive images taken from the image capture device 106 and then may associate a position or measurements from the image capture device 106 to assist in determining a position of the image capture device 106 at or near the time the images were captured. The measurements and/or positional information may be associated with the images that were captured at or near when the measurements were taken and used to generate a model (e.g., 3D visualization walkthrough model) by the smart phone, online platform, and/or another digital device.

In some embodiments, each image may be associated with a reference time of the image capture device 106 and the measurements of signal strength may also be associated with a reference time on the image capture device 106, thereby allowing the images to be associated with the signal strength at the time of capture to assist in determining position and/or orientation of the image capture device 106 at the time of capture.

In various embodiments, the smart phone is positioned at or near an image capture device 106 and oriented in a direction such that the camera of the smartphone is oriented in the same direction as the image capture device 106. The smart phone may generate measurements of the strength of any number of the positioning signals from any number of the anchor systems 102 to the smart phone (e.g., in real time). The smart phone may receive images taken from the image capture device 106 and then may associate a position or measurements from the smartphone to assist in determining a position of the image capture device 106 at or near the time the images were captured (e.g., each image may be associated with a reference time of the image capture device 106 and the measurements of signal strength may also be associated with a reference time on the smart phone, thereby allowing the images to be associated with the signal strength at the time of capture to assist in determining position and/or orientation of the image capture device 106 at the time of capture).

In optional step 512, the smart phone receives depth data captured by depth data device (e.g., of the image capture device 106 or a separate device) and associates the depth data with position relative to one or more anchor system(s) 102 at time of depth data capture. As discussed herein, in some embodiments, each portion of depth data (e.g., a subset) may be associated with a reference time of the image capture device 106 or depth device and the measurements of signal strength may also be associated with a reference time on the image capture device 106 or depth device, thereby allowing the portions or subsets of depth data to be associated with the signal strength at the time of capture to assist in determining position and/or orientation of the image capture device 106 or depth data at the time of capture.

The images and depth data as well as orientation and position at time of capture of the images and depth data may be utilized to assist in improving dimensional and positional accuracy of model creation.

In step 514, the smart phone (or any digital device) may provide images, associated information with images, and optionally depth data as well as associated information with depth data to online platform to assist with creation of 3D model. The associated information may be, for example, positional information, measurements, position relative to any number of anchor system(s) 102, orientation, and/or the like.

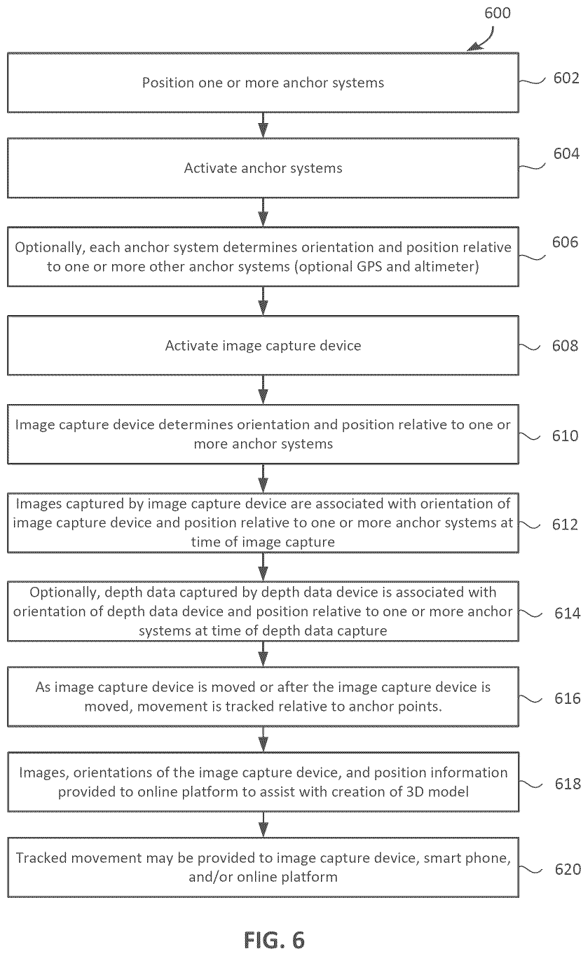

FIG. 6 is a flowchart 600 for tracking movement of an image capture device 106 utilizing one or more anchor system(s) 102 in some embodiments. It will be appreciated that steps 602-614 of FIG. 6 are similar to steps 402-414 of FIG. 4.

In step 602, one or more anchor system(s) 102 are positioned in an environment. In step 604, each anchor system 102 is activated.

In step optional step 606, each anchor system 102 may determine its position relative to one or more of the other anchor systems 102. For example, an anchor system 102 may determine the strength and/or position of a positioning signal (e.g., UWB) of other anchor systems 102 to determine or assist in determining its own position. In various embodiments, the anchor system 102 may utilize the UWB module 202 to provide and receive UWB signals. The UWB module 202 may also determine position of the anchor system 102 based on received UWB signals. In some embodiments, one or more of the anchor system(s) 102 may determine its orientation (e.g., via the orientation module). In various embodiments, the orientation module 204 may determine orientation manually by a user, through determining of magnetic north, and/or any number of other measurements).

In step 608, a user may activate the image capture device 106. In step 610, the image capture device 106 determines its orientation and position relative to one or more of the activated anchor system(s) 102. In various embodiments, the image capture device 106 is configured to receive or detect positioning signals (e.g., UWB signals) from the one or more anchor system(s) 102. Utilizing strength of signal and triangulation, the image capture device 106 may determine its relative position. Alternately, the image capture device 106 may determine the strength and/or orientation of the positioning signals and provide those measurements as well as the time of the measurements to another digital device (e.g., smart phone, anchor system 102, and/or online platform) to associate location and images.

It will be appreciated that the positioning signals from the one or more anchor system(s) 102 may be utilized to create a local coordinate reference system to enable determination of a position of the image capture device 106 at the time images are captured. In some embodiments, additionally, the positioning signals from the one or more anchor system(s) 102 may be utilized to create a local coordinate reference system to enable determination of an orientation of the image capture device 106 at the time images are captured.

In some embodiments, the orientation of the image capture device 106 may determined based on the positioning signals of the anchor system(s) 102. In various embodiments, the anchor system(s) 102 may provide additional signals to assist in determining orientation of the image capture device 106.

In step 612, images captured by the image capture device 106 are associated with orientation of the image capture device 106 and position of the image capture device 106 at the time of capture. In various embodiments, the image capture device 106 associates particular images with the measurements of the strength of any number of positioning signals of any number of anchor system(s) 102 before image capture, at the time of image capture or after image capture. The associated information (e.g., metadata or separate data stream) may be provided to a smart phone (e.g., via a Wi-Fi, Bluetooth, or other protocol) and/or an online platform (e.g., a third party server over the Internet).

In some embodiments, the image capture device 106 may periodically or constantly measure the strength of positioning signal(s) from any number of anchor system(s) 102 and provide the measurements along with images or image identifiers to another digital device (e.g., smart phone or another anchor system) in real time. The other digital device may associate the denote the images with the measurements or a determined location (and/or orientation) of the image capture device 106 at or near the time the image(s) were captured.

In optional step 614, depth data captured by depth data device is associated with orientation of depth data device and position relative to one or more anchor systems at time of depth data capture. The depth data device may be any device capable of determining depth (e.g., LiDAR, laser, and/or the like). In some embodiments, the depth data device is separate from the image capture device 106 (e.g., a separate device or accessory that may be coupled to the image capture device 106 as discussed herein). In various embodiments, the depth data device is a part of the image capture device 106 (e.g., the image capture device 106 may capture both images and depth data such as the Matterport Pro3).

It will be appreciated that the depth data may be associated with the position or measurements of the position of the anchor system 102 in a manner similar to that described with regard to images.

For example, depth data captured by the image capture device 106 or a separate depth device may be associated with orientation of the age capture device 106 or a separate depth device and position of the image capture device 106 or a separate depth device at the time of capture. In various embodiments, the image capture device 106 or a separate depth device associates particular depth data with the measurements of the strength of any number of positioning signals of any number of anchor system(s) 102 before depth data capture, at the time of depth data capture or after depth data capture. The associated information (e.g., metadata or separate data stream) may be provided to a smart phone (e.g., via a Wi-Fi, Bluetooth, or other protocol) and/or an online platform (e.g., a third party server over the Internet).

In some embodiments, the image capture device 106 or a separate depth device may periodically or constantly measure the strength of positioning signal(s) from any number of anchor system(s) 102 and provide the measurements along with depth data or depth data identifiers to another digital device (e.g., smart phone or another anchor system) in real time. The other digital device may associate the denote the depth data with the measurements or a determined location (and/or orientation) of the image capture device 106 or a separate depth device at or near the time the depth data was captured.

In step 616, as an image capture device 106 is moved from one position to another, the movement may be tracked relative to anchor system(s) 102. It will be appreciated that any number of image capture devices 106 may be moved to capture images and/or depth information of the environment (e.g., different portions, different floors, and/or the like).

In various embodiments, the image capture device 106, one or more anchor system(s) 102, and/or another digital device (e.g., smart phone) may track the strength of signal of the positioning signals to assist in tracking movement relative to the positioning signals (and thereby relative to the anchor system(s) 102. The image capture device 106, one or more anchor system(s) 102, and/or another digital device may track and log the path of movement of the image capture device 106 until movement ceases and then a new position using the positioning signals may be determined.

In some embodiments, movement is not tracked, but the image capture device 106, one or more anchor system(s) 102, and/or another digital device determines when an image capture device 106 is no longer moving and then a new position is determined to be associated with images and/or depth data taken from the new position and/or orientation.

In step 618, the image capture device 106 or a separate depth device may provide images, orientation of the image capture device 106 at or near the time of image capture, position of the image capture device 106 at or near the time of image capture (relative to the positioning signals from the one or more anchor systems 102), depth data, orientation of the image capture device 106 or depth device at or near the time of depth data capture, and/or position of the image capture device 106 or depth device at or near the time of depth data capture (relative to the positioning signals from the one or more anchor systems 102) to an online platform (e.g., server over the Internet) or other device (e.g., smart phone or laptop). In some embodiments, the smart phone or laptop may provide all or some of the information (preprocessed or not processed) to the online platform.

The images, depth data, indications (e.g., measurements) of position of the image capture device 106 when one or more images are captured, orientation indications (e.g., measurements) of the image capture device 106 when one or more images are captured, indications(e.g., measurements) of position of the image capture device 106 or depth device when depth data is captured, orientation indications (e.g., measurements) of the image capture device 106 or depth device when depth data is captured, may be used to generate model of the environment (e.g., improvement dimensional and positional accuracy).

In some embodiments, in step 620, tracked movements may be provided to the image capture device 106, one or more anchor system(s) 102, other digital device, and/or the online platform to assist in insuring an environment is covered and provide an audit of the capture process (e.g., logs of events taken during capture).

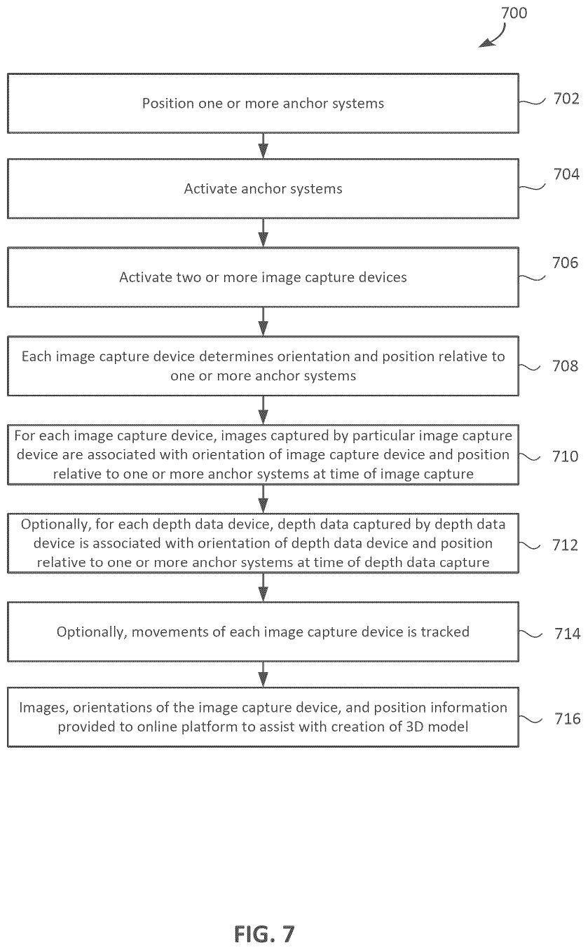

FIG. 7 is a flowchart 700 for team scanning using any number of image capture devices 106 utilizing one or more anchor system(s) 102 in some embodiments. In various embodiments, several users, robots, drones, and/or the like may control two or more image capture devices 106 to capture images and/or depth information about a space more quickly and/or accurately.

In step 702, one or more anchor system(s) 102 are positioned in an environment. In step 704, each anchor system 102 is activated. In step 706, each image capture device 106 is activated (e.g., by individual users, drones, robots, and/or the like). The image capture devices 106 may be spaced in different locations, elevations, or the like in the same environment (e.g., different parts and/or different floors of a building).

In step 708, each image capture device 106 determines its orientation and position relative to one or more of the activated anchor system(s) 102. In various embodiments, each image capture device 106 is configured to receive or detect positioning signals (e.g., UWB signals) from the one or more anchor system(s) 102. Utilizing strength of signal and triangulation, each image capture device 106 may determine its relative position. Alternately, each image capture device 106 may determine the strength and/or orientation of the positioning signals and provide those measurements as well as the time of the measurements to another digital device (e.g., smart phone, anchor system 102, and/or online platform) to associate location and images.

It will be appreciated that the positioning signals from the one or more anchor system(s) 102 may be utilized to create a local coordinate reference system to enable determination of a position of the image capture device 106 at the time images are captured. In some embodiments, additionally, the positioning signals from the one or more anchor system(s) 102 may be utilized to create a local coordinate reference system to enable determination of an orientation of each image capture device 106 at the time images are captured.

In some embodiments, the orientation of each image capture device 106 may determined based on the positioning signals of the anchor system(s) 102. In various embodiments, the anchor system(s) 102 may provide additional signals to assist in determining orientation of each image capture device 106.

In step 710, images captured by each image capture device 106 are associated with orientation of the particular image capture device 106 and position of the particular image capture device 106 at the time of capture. In various embodiments, each image capture device 106 associates particular images with the measurements of the strength of any number of positioning signals of any number of anchor system(s) 102 before image capture, at the time of image capture or after image capture. The associated information (e.g., metadata or separate data stream) may be provided to a smart phone (e.g., via a Wi-Fi, Bluetooth, or other protocol) and/or an online platform (e.g., a third party server over the Internet).

In some embodiments, each image capture device 106 may periodically or constantly measure the strength of positioning signal(s) from any number of anchor system(s) 102 and provide the measurements along with images or image identifiers to another digital device (e.g., smart phone or another anchor system) in real time. The other digital device may associate the denote the images with the measurements or a determined location (and/or orientation) of the image capture device 106 at or near the time the image(s) were captured.

In optional step 712, depth data captured by depth data device is associated with orientation of depth data device and position relative to one or more anchor systems at time of depth data capture. The depth data device may be any device capable of determining depth (e.g., LiDAR, laser, and/or the like). In some embodiments, the depth data device is separate from any number of image capture device(s) 106 (e.g., a separate device or accessory that may be coupled to an image capture device 106 as discussed herein). In various embodiments, a depth data device is a part of each image capture device 106 (e.g., each image capture device 106 may capture both images and depth data such as the Matterport Pro3).

It will be appreciated that the depth data may be associated with the position or measurements of the position of the anchor system 102 in a manner similar to that described with regard to images.

In step 714, as each image capture device 106 is moved from one position to another, the movement may be tracked relative to anchor system(s) 102. In various embodiments, each image capture device 106, one or more anchor system(s) 102, and/or another digital device (e.g., smart phone) may track the strength of signal of the positioning signals to assist in tracking movement relative to the positioning signals (and thereby relative to the anchor system(s) 102. Each image capture device 106, one or more anchor system(s) 102, and/or another digital device may track and log the path of movement of any number of image capture device(s) 106 until movement ceases and then a new position using the positioning signals may be determined.

In some embodiments, movement is not tracked, but when an image capture device 106, one or more anchor system(s) 102, and/or another digital device determines when a particular image capture device 106 is no longer moving and then a new position is determined to be associated with images and/or depth data taken from the new position and/or orientation.

In step 716, each image capture device 106 and/or separate depth device(s) may provide images, orientation of a particular image capture device 106 at or near the time of image capture, position of a particular image capture device 106 at or near the time of image capture (relative to the positioning signals from the one or more anchor systems 102), depth data, orientation of a particular image capture device 106 or depth device at or near the time of depth data capture, and/or position of a particular image capture device 106 or depth device at or near the time of depth data capture (relative to the positioning signals from the one or more anchor systems 102) to an online platform (e.g., server over the Internet) or other device (e.g., smart phone or laptop). In some embodiments, the smart phone or laptop may provide all or some of the information (preprocessed or not processed) to the online platform.

The images, depth data, indications (e.g., measurements) of positions of the image capture device 106 when one or more images are captured, orientation indications (e.g., measurements) of the image capture devices 106 when one or more images are captured, indications(e.g., measurements) of position of the image capture devices 106 or depth devices when depth data is captured, orientation indications (e.g., measurements) of the image capture devices 106 or depth devices when depth data is captured, may be used to generate model of the environment (e.g., improvement dimensional and positional accuracy).

In some embodiments, tracked movements may be provided to the image capture devices 106, one or more anchor system(s) 102, other digital device, and/or the online platform to assist in insuring an environment is covered and provide an audit of the capture process (e.g., logs of events taken during capture).

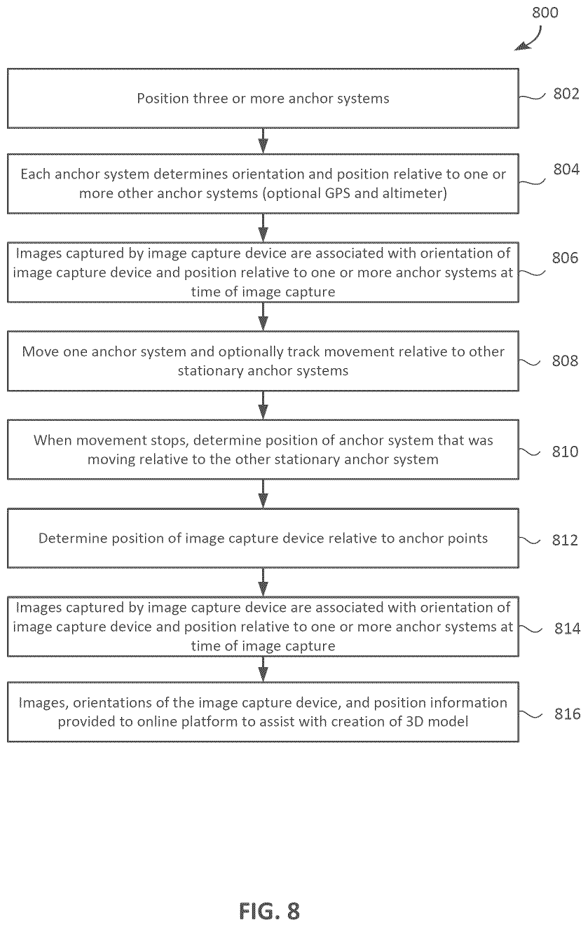

FIG. 8 is a flowchart 800 for moving one or more anchor system(s) 102 in some embodiments. In various embodiments, a limited number of anchor systems 102 are used to assist in determining position and/or orientation of any number of image capture device(s) 106 in an environment. Due to the size of the environment, multiple floors, attenuation of signals, blockages, interference, and/or the like, one or more anchor system(s) 102 may be moved to extend or augment the local coordinate system (e.g., extending positioning relative to the localized reference). In one example, four anchor systems 102 may be positioned in an environment. Each of the anchor systems 102 may determine its location relative to the other anchor systems 102. After images are taken of a particular part of the environment, one of the anchor systems 102 may be moved to a new location (e.g., to a different floor or a different part of the environment). The position of the moving anchor system 102 may optionally be tracked. Once in its new location, the anchor system 102 may establish its position relative to the other anchor systems 102 (e.g., via positioning signals). Even though an anchor system 102 was moved, the system may track where the anchor system 102 was originally positioned relative to the new position, thereby extending the positioning system in a manner that is consistent with the previous position. As a result, the position of the image capture device 106 in a new location may be determined based on the anchor systems 102 (including the one that was moved) and this position of the new images in the new location may be associated with the same coordinate or localized reference system thereby providing dimensional and positional accuracy across all images.

In step 802, three or more anchor systems 102 are positioned in an environment. In step 804, each anchor system 102 may determine its position relative to one or more of the other anchor systems 102. For example, an anchor system 102 may determine the strength and/or position of a positioning signal (e.g., UWB) of other anchor systems 102 to determine or assist in determining its own position. In various embodiments, the anchor system 102 may utilize the UWB module 202 to provide and receive UWB signals. The UWB module 202 may also determine position of the anchor system 102 based on received UWB signals. In some embodiments, one or more of the anchor system(s) 102 may determine its orientation (e.g., via the orientation module). In various embodiments, the orientation module 204 may determine orientation manually by a user, through determining of magnetic north, and/or any number of other measurements).

In step 806, each image capture device 106 determines its orientation and position relative to one or more of the activated anchor system(s) 102. In various embodiments, each image capture device 106 is configured to receive or detect positioning signals (e.g., UWB signals) from the one or more anchor system(s) 102. Utilizing strength of signal and triangulation, each image capture device 106 may determine its relative position. Alternately, each image capture device 106 may determine the strength and/or orientation of the positioning signals and provide those measurements as well as the time of the measurements to another digital device (e.g., smart phone, anchor system 102, and/or online platform) to associate location and images.

It will be appreciated that the positioning signals from the one or more anchor system(s) 102 may be utilized to create a local coordinate reference system to enable determination of a position of the image capture device 106 at the time images are captured. In some embodiments, additionally, the positioning signals from the one or more anchor system(s) 102 may be utilized to create a local coordinate reference system to enable determination of an orientation of each image capture device 106 at the time images are captured.

In some embodiments, the orientation of each image capture device 106 may determined based on the positioning signals of the anchor system(s) 102. In various embodiments, the anchor system(s) 102 may provide additional signals to assist in determining orientation of each image capture device 106.

In step 808, one of the anchor systems 102 is moved to a different location in the environment. As the anchor systems 102 is moved from one position to another, the movement may be tracked relative to the other anchor systems 102. It will be appreciated that any number of the anchor systems 102 may be moved. Similarly, any number of image capture device 106 may also be moved to capture images and/or depth information of the environment (e.g., different portions, different floors, and/or the like) and take advantage of the positioning signal provided by the new location of the anchor system 102.

In various embodiments, the image capture device 106, one or more anchor system(s) 102, and/or another digital device (e.g., smart phone) may track the strength of signal of the positioning signals to assist in tracking movement relative to the positioning signals (and thereby relative to the anchor system(s) 102. The image capture device 106, one or more anchor system(s) 102, and/or another digital device may track and log the path of movement of the anchor systems 102 until movement ceases and then a new position using the positioning signals may be determined. In some embodiments, movement is not tracked.

In step 810, when the image capture device 106, one or more anchor system(s) 102, and/or another digital device determines when the anchor systems 102 is no longer moving, and then a new position is determined to be associated with images and/or depth data taken from the new position and/or orientation.

In step 812, the image capture device 106 determines its location relative to the anchor systems 102 (including the anchor system 102 that has moved) in a manner similar to that described herein.

In step 814, the image capture device 106 or a separate depth device may provide images, orientation of the image capture device 106 at or near the time of image capture, position of the image capture device 106 at or near the time of image capture (relative to the positioning signals from the one or more anchor systems 102), depth data, orientation of the image capture device 106 or depth device at or near the time of depth data capture, and/or position of the image capture device 106 or depth device at or near the time of depth data capture (relative to the positioning signals from the one or more anchor systems 102) to an online platform (e.g., server over the Internet) or other device (e.g., smart phone or laptop). In some embodiments, the smart phone or laptop may provide all or some of the information (preprocessed or not processed) to the online platform.

In step 816, the images, depth data, indications (e.g., measurements) of position of the image capture device 106 when one or more images are captured, orientation indications (e.g., measurements) of the image capture device 106 when one or more images are captured, indications(e.g., measurements) of position of the image capture device 106 or depth device when depth data is captured, orientation indications (e.g., measurements) of the image capture device 106 or depth device when depth data is captured, may be used to generate model of the environment (e.g., improvement dimensional and positional accuracy).

In some embodiments, tracked movements may be provided to the image capture device 106, one or more anchor system(s) 102, other digital device, and/or the online platform to assist in insuring an environment is covered and provide an audit of the capture process (e.g., logs of events taken during capture).

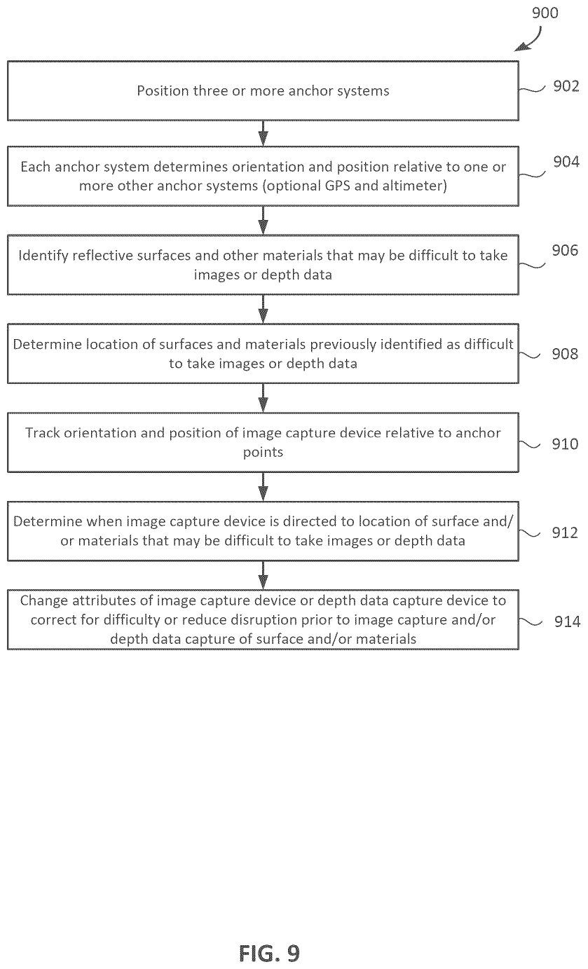

FIG. 9 is a flowchart 900 for identifying positions of difficult surfaces and materials utilizing anchor systems 102 in some embodiments. It will be appreciated that some surfaces and materials may be difficult to measure using depth sensors. For example, the reflectivity of some surface may provide error for LiDAR or other technologies. In some embodiments, positions within the environment may be marked as including materials or surfaces difficult to image or detect depth. The positions may be identified using anchor systems as described herein. When one or more of these positions are identified, changes can be made to the image capture device 106 and/or depth device to assist in determining how best to capture images and/or depth data at that position. Similarly, images or depth data taken at those positions may be processed differently (e.g., through a model configured to improve accuracy for that type of surface or material) to improve accuracy. It will be appreciated that these steps may be in any order.

In step 902, any number of anchor systems 102 may be positioned in an environment. In step 904, each anchor system 102 may determine its position relative to one or more of the other anchor systems 102. For example, an anchor system 102 may determine the strength and/or position of a positioning signal (e.g., UWB) of other anchor systems 102 to determine or assist in determining its own position. In various embodiments, the anchor system 102 may utilize the UWB module 202 to provide and receive UWB signals. The UWB module 202 may also determine position of the anchor system 102 based on received UWB signals. In some embodiments, one or more of the anchor system(s) 102 may determine its orientation (e.g., via the orientation module). In various embodiments, the orientation module 204 may determine orientation manually by a user, through determining of magnetic north, and/or any number of other measurements).

In some embodiments, an image capture device 106 determines its orientation and position relative to one or more of the activated anchor system(s) 102. In various embodiments, each image capture device 106 is configured to receive or detect positioning signals (e.g., UWB signals) from the one or more anchor system(s) 102. Utilizing strength of signal and triangulation, each image capture device 106 may determine its relative position. Alternately, each image capture device 106 may determine the strength and/or orientation of the positioning signals and provide those measurements as well as the time of the measurements to another digital device (e.g., smart phone, anchor system 102, and/or online platform) to associate location and images.

In step 906, areas that are difficult to capture images and/or depth data (e.g., certain reflective surfaces and materials) may be identified. In some embodiments, a user may identify them visually. In some embodiments, the image capture device 106 or smartphone may identify surfaces or materials that may be difficult to capture images or depth data (e.g., via software that identifies those surfaces or materials).

In step 908, a location of the surfaces and materials previously identified as difficult to take images of depth data is determined relative to the positioning signals of any number of anchor systems 102. In some embodiments, the position and orientation of the image capture device are measured as discussed herein when pointed at a surface or material that is difficult to measure. A user or software may mark that position or those measurements as being associated with a difficult surface or material Alternately, a smartphone may be used to identify the locations as discussed herein (e.g., relative to the positioning signals of any number of anchor systems 102).

In step 910, as discussed herein, positions and orientation of an image capture device or depth device are determined when images and/or depth data are captured. The positions and orientations may be tracked.

In step 912, the image capture device 106, anchor system(s) 102, and/or other digital device may determine when the image capture device is directed to the surface or material. In various embodiments, the position and/or orientation of the image capture device 106 may be compared to the previously determined location or position of the surface or material.

In some embodiments, in step 914, the user or software may change attributes of the image capture device 106 and/or depth device to correct for difficulty (or add additional information) or reduce disruption prior to image capture and/or depth data capture of the surface or material. For example, additional images and/or depth data may be taken of the surface or material. Alternately or additionally, additional images and/or depth data of the surface or material may be taken from different orientations and positions to improve information capture.

In some embodiments, the other digital device (e.g., smartphone and/or online platform) may determine when certain images are taken of the surface or material (e.g., by matching positions and orientation of the image capture device 106 relative to the previously determined position of the surface or material), and the other digital device may process the information (e.g., images and/or depth data) using models for the particular surface or material (e.g., process or pre-process) to improve accuracy and assist creation of more accurate 3D model visualizations.

In various embodiments, a sensor component is device that may couple and/or communicate with an image capture device 106. The sensor component may include any number of sensors configured to assist in scanning the environment 104. In one example, the sensor component is couplable to the image capture device 106 (e.g., with a camera mount and/or magnetic mount). The sensor component may include any number of sensors (e.g., Indirect Time of Flight (iToF) and/or direct Time of Flight (ToF) sensors) that may be used to obtain information of the environment 104. In some embodiments, the sensor component enables the addition of sensor information and measurements that may not be present in the image capture device 106. As such, in one example, the image capture device 106 may be coupled to the sensor component, and the image capture device 106 may be used to capture images of the environment and the sensor component may take depth measurements of the environment. The depth measurements and images may be associated with other depth information, and images taken at a different location within the environment are based, in part, on the positioning information to enable improved accuracy and/or speed in generating a 3D model.

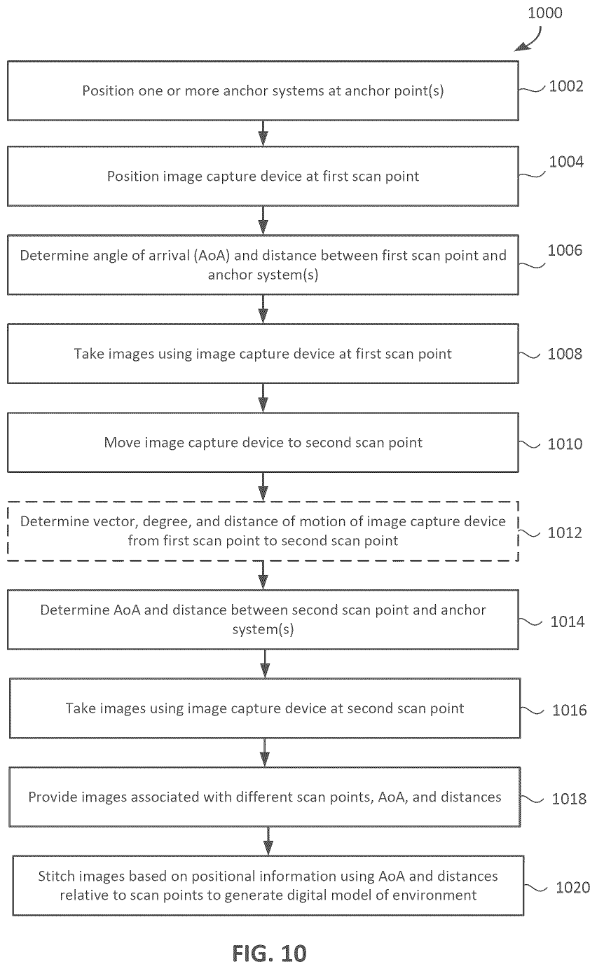

FIG. 10 is a flowchart 1000 depicting a method for tracking movement and/or position of an image capture device 106 in some embodiments. One or more of the steps of FIG. 10 may be utilized in conjunction or in place of all of some of the steps of FIG. 6.

In step 1002, one or more anchor system(s) 102 are positioned in an environment. In step 604, each anchor system may be activated. In some embodiments, each anchor system 102 may determine its position relative to one or more of the other anchor systems 102. For example, an anchor system 102 may determine the strength and/or position of a positioning signal (e.g., UWB) of other anchor systems 102 to determine or assist in determining its own position as discussed with regard to FIG. 6. In some embodiments, each anchor system 102 may determine the angle of arrival and distance for one or more other anchor system 102 positioned in the environment.

Angle of Arrival (AoA) is a method used in wireless communications to determine the direction from which a received signal was transmitted. In one example, one or more of the anchor system 102 may have different antenna elements positioned at different positions within the anchor system (e.g., at different corners or positions of the anchor system 102). In one example, the anchor system may be pyramidal in shape with three or four different surfaces housing or being coupled to a different antenna element (e.g., different antennas of an antenna array). The anchor system 102 may receive, determine, or estimate the vector and degree from the signal received from one or more of the different antennas. The anchor system 102 and/or another digital device (e.g., another anchor system, smart phone, laptop, platform in the cloud, or any digital device that receives the vector and degree measurements) may utilize that information to determine or estimate the AoA. It will be appreciated that, in some embodiments, the AoA is not determined and the vector and degree is utilized to help determine a position of another anchor system 102.

The anchor system 102 may utilize AoA (or only the vector and degree measurements) to estimate the direction of the incoming signal by measuring the phase or time difference as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the anchor system 102 may utilize the AoA estimation and the strength of signal (e.g., utilizing a Received Signal Strength Indicator (RSSI)) to determine AoA and distance between the anchor system 102 and any number of other anchor systems. In some embodiments, the anchor system 102 may additionally use a time of arrival (ToA) to further determine the direction and distance of another anchor system.

In step 1004, the image capture device 106 may be positioned at a first scan point. A first scan point is a position in the environment to be scanned (e.g., by images, LiDAR, or both). In one example, the image capture device 106 is positioned at a location that is not predetermined; that position may become the first scan point as discussed herein.

After being positioned, the image capture device 106 may be activated by the user (e.g., turned on). The image capture device may be able to communicate with one or more anchor systems 102 (e.g., utilizing UWB, Bluetooth, Zigbee, Wi-Fi, or the like). Once turned on and/or commanded to communicate with one or more of the anchor systems 102, the image capture device 106 may provide a signal to one or more of the anchor systems 102 (e.g., all or a subset of the available anchor systems 102 within or near the environment).

In step 1006, one or more of the anchor systems 102 may determine the angle of arrival AoA and distance between the image capture device 106 at the first scan point. For example, an anchor system 102 may determine the AoA and distance in the manner discussed above.

In some embodiments, for example, an anchor system 102 may determine the strength and/or position of a positioning signal from the image capture device 106. In some embodiments, each anchor system 102 may determine the angle of arrival and distance for the image capture device 106 at the first scan point.

As discussed herein, an anchor system 102 may have different antenna elements positioned at different positions within the anchor system (e.g., at different corners or positions of the anchor system 102). The anchor system 102 may receive a positioning signal from the image capture device 106 and take measurements to generate the vector and degree based on the positioning signal using one or more of the different antennas. The anchor system 102 and/or another digital device (e.g., another anchor system, smart phone, laptop, platform in the cloud, or any digital device that receives the vector and degree measurements) may utilize that information to determine or estimate the AoA relative to the image capture device 106 at the first scan point. It will be appreciated that, in some embodiments, the AoA is not determined, and the vector and degree are utilized to help determine a position of the image capture device 106.

The anchor system 102 may utilize AoA (or only the vector and degree measurements) to estimate the direction of the incoming signal by measuring the phase or time difference as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the anchor system 102 may utilize the AoA estimation and the strength of signal (e.g., utilizing a Received Signal Strength Indicator (RSSI)) to determine AoA and distance between the anchor system 102 to the image capture device 106.

Although a single image capture device 106 is described in this example, it will be appreciated that there may be any number of image capture devices 106 that may be positioned and their positions (e.g., their particular scan points) may be determined by the same anchor system 102 and/or any number of anchor systems 102.

Similarly, there may be any number of anchor systems 102 that may be utilized to assist in improving the accuracy of the location of the image capture device 106. For example, each of three or more anchor systems 102 may take measurements of any number of positioning signals from the image capture device 106 to determine the AoA and distance to the image capture device 106 at the first scan point. It will be appreciated that using additional anchor systems 102 to determine the AoA and distance to the same image capture device 106 may assist to improve accuracy of the position relative to the anchor systems 102 (e.g., utilizing triangulation). In some embodiments, each of the anchor systems 102 may provide their measurements (e.g., vector, degree, and signal strength) to another anchor system 102 (e.g., a “master” anchor system 102), the image capture device 106, and/or another digital device (e.g., smart phone, laptop, or digital device on the cloud) which may use the measurements to determine the location and/or position of the image capture device 106 at the first scan point.

In step 1008, the image capture device 106 may take images and/or measurements (e.g., LiDAR or the like) of the environment at the first scan point. In various embodiments, the image capture device 106 takes images and/or measurements at 360 degrees around the first scan point (e.g., the image capture device 106 may rotate and/or have sensors such that the images and/or measurements may be taken at any number of degrees at a starting orientation of the image capture device 106). The image capture device 106 may be or include, for example, the sensor component 1100.

In step 1010, the image capture device 106 is moved from the first scan point to a second scan point. In one example, the image capture device 106 may be moved by a user physical (e.g., lifting up the image capture device 106 and moving the device to a new location). In some embodiments, the image capture device 106 may be or include a drone, robot, or the like that may be commanded to move over a path to a new location (e.g., to the second scan point).

In optional step 1012, the path of the image capture device 106 may be measured by one or more of the anchor systems 102. In one example, while the image capture device 106 is being moved, the image capture device 106 may continue to provide the positioning signal, which may be received by one or more of the anchor systems 102 (e.g., the same anchor system(s) 102 that determine the AoA to the image capture device 106 when at the first scan point). While being moved, one or more of the anchor system(s) 102 may determine the vector, degree, and/or distance of motion to the moving image capture device 106 (e.g., based on receiving the positioning signal during movement). Each of the one or more anchor system(s) 102 may provide the vector, degree, and/or distance to another digital device (e.g., one of the anchor systems 102, the image capture device 106 that was moved, and/or a digital device (e.g., smart phone, laptop, or digital device in the cloud). Alternately or additionally, the anchor system 102, which performs its particular measurements, may store the information.

It will be appreciated that the vector, degree, and/or distance of motion may be used to track paths taken by the image capture device 106. The paths may be used to analyze if all (or at least desired) portions of the environment have been captured by the image capture device(s) 106. In some embodiments, one or more of the image capture device 106 may capture images and/or other measurements during motion. The images and/or other measurements may be associated with the information captured (e.g., by the one or more anchor system(s) 106) during movement. As a result, the position of the path between scan points can be tracked and added to the 3D model (e.g., digital twin) navigation (e.g., a user can navigate along the paths and watch images, observe measurements, or see virtual images along the path).

In some embodiments, the image capture device 106 may include an accelerometer or other device (e.g., GPS or the like) configured to determine when the image capture device 106 is in motion. While in motion, in some embodiments, the image capture device 106 may provide notice to any number of the anchor system(s) 102 to indicate that the image capture device 106 is in motion along the path and that measurements may be taken differently (e.g., to expect a more dynamic change over a short time in measurements) and/or associated with the path of the image capture device 106.

Steps 1014 and 1016 may be similar to steps 1006 and 1008 relative to a new scan point. In step 1014, one or more of the anchor systems 102 may determine the angle of arrival AoA and distance between the image capture device 106 at the next (e.g., second) scan point. For example, the anchor system 102 may determine the AoA and distance in the manner discussed above.

In some embodiments, for example, an anchor system 102 may determine the strength and/or position of a positioning signal from the image capture device 106. In some embodiments, each anchor system 102 may determine the angle of arrival and distance for the image capture device 106 at the second scan point.

The anchor system 102 may utilize AoA (or only the vector and degree measurements) to estimate the direction of the incoming signal by measuring the phase or time difference as the signal arrives at different elements of an antenna array. In one example, the signal may reach each antenna element at slightly different times, depending on the angle of arrival. By comparing the signals (e.g., measurements of vector and degree) received at any number of antenna elements, the anchor system 102 may calculate the angle from which the signal originates relative to the orientation of the antenna array.

In various embodiments, the anchor system 102 may utilize the AoA estimation and the strength of signal (e.g., utilizing a Received Signal Strength Indicator (RSSI)) to determine AoA and distance between the anchor system 102 to the image capture device 106 at the second scan point.

Although a single image capture device 106 is described in this example, it will be appreciated that there may be any number of image capture devices 106 that may be positioned and their positions (e.g., their particular scan points) may be determined by the same anchor system 102 and/or any number of anchor systems 102.

Similarly, there may be any number of anchor systems 102 that may be utilized to assist in improving the accuracy of the location of the image capture device 106. For example, each of three or more anchor systems 102 may take measurements of any number of positioning signals from the image capture device 106 to determine the AoA and distance to the image capture device 106 at the second scan point. In some embodiments, a first set of anchor systems 102 that take measurements of any number of positioning signals from the image capture device 106 at the first scan point and there may be another, different set of anchor systems 102 that take measurements of any number of positioning signals from the image capture device 106 at a different scan point (e.g., the second scan point).

In step 1016, the image capture device 106 may take images and/or measurements (e.g., LiDAR or the like) of the environment at the second scan point. In various embodiments, the image capture device 106 takes images and/or measurements at 360 degrees around the second scan point (e.g., the image capture device 106 may rotate and/or have sensors such that the images and/or measurements may be taken at any number of degrees at a starting orientation of the image capture device 106).

In step 1018, images may be provided to a digital device (e.g., smartphone, laptop, website, cloud platform, or the like). Similarly, the positional information (e.g., AoA, distances, and/or degrees) associated with the images and/or measurements may be provided to the digital device. For example, each image or group of images may be associated with positional information of the digital device at time of image capture. The positional information, as discussed herein, is generated by one or more anchor system(s) 102 based on the positioning signals communicated by or received by the image capture device 106.

In step 1020, the digital device or system (e.g., platform) may stitch the images to generate the digital model of the environment. In various embodiments, each image or set of images is associated with a position (e.g., scan point or path). The images may also be associated with positional information (the images may have positional information as metadata). The positional information may indicate a position within the environment. The position may be determined based on the AoA and distances provided by any number of anchor system(s) 102. Based on the position and image capture device 106 orientation at the time of capture, images may be aligned, oriented, and/or stitched together. This step is optional.

In one example, the locations of the scans (e.g., the scan positions of the image capture device when capturing one or more sets of images of the environment) may be used to by a stitching vision pipeline (e.g., in the cloud) to relocate the scan points and align or re-align images and/or depth data (e.g., data cloud) based on scan locations. This information may inform the vision pipeline of minor and major mis-alignments in the scan locations. As a result, the stitching becomes assisted-stitching. The stitching vision pipeline may collect angle and distance information from image capture device(s) to anchor system(s) and also from anchor system(s) to image capture device(s). As well as anchor system to anchor system, this may correct for the ability for the camera to rotate when moved.

It will be appreciated that any number of the image capture device(s) 106 may move from a scan point to another scan point (e.g., there may be more than two scan points) at which time optional step 1012 and steps 1014 and 1016 may repeat until scanning of the environment is complete.

Although an image capture device 106 is discussed with regard to FIG. 10, it will be appreciated that any number of devices may provide positioning signals to the anchor system(s) in a similar manner as that which was discussed herein. For example, an image capture device 106 and a separate depth device may provide positioning signals when stationary to the anchor system(s) 102 and the anchor system(s) 102 may determine the AoA and distance to each device. Similarly, the image capture device 106 and the separate depth device may provide positioning signals when mobile to the anchor system(s) 102 and the anchor system(s) 102 may take measurements and/or determine vector, degree, and distance of the path between scan points.

The image capture device 106 or a separate depth device may provide images, orientation of the image capture device 106 at or near the time of image capture, position of the image capture device 106 at or near the time of image capture (relative to the positioning signals from the one or more anchor systems 102), depth data, orientation of the image capture device 106 or depth device at or near the time of depth data capture, and/or position of the image capture device 106 or depth device at or near the time of depth data capture (relative to the positioning signals from the one or more anchor systems 102) to an online platform (e.g., server over the Internet) or other device (e.g., smart phone or laptop). In some embodiments, the smart phone or laptop may provide all or some of the information (preprocessed or not processed) to the online platform.

The images, depth data, indications (e.g., measurements) of position of the image capture device 106 when one or more images are captured, orientation indications (e.g., measurements) of the image capture device 106 when one or more images are captured, indications(e.g., measurements) of position of the image capture device 106 or depth device when depth data is captured, orientation indications (e.g., measurements) of the image capture device 106 or depth device when depth data is captured, may be used to generate model of the environment (e.g., improvement dimensional and positional accuracy).

Further, in some embodiments, elevation of the motion of the image capture device 106 may be tracked. It will be appreciated that the image capture device 106 and/or a depth device may capture its elevation (e.g., via an altimeter, barometer, and/or the like). In some embodiments, one or more of the anchor system(s) 102 may track elevation based on signal direction. The elevation may indicate a change in floors, stairwells, or the like. In some embodiments, the change of elevation may be used to track motion and path of a mobile image capture device 106 (e.g., on a drone, pole, robot, and/or the like).

In various embodiments, location information associated with scan points and/or paths between scan points taken by the image capture device(s) 106 may be associated with images and/or measurements taken at those scan points and/or during movement along the paths. The location information may then be used to assist with stitching, aligning, and/or combining images and/or measurements of any number of image capture device(s) 106 to create a 3D model or digital twin of all or part of the environment. The location information may include, for example, AoA estimates, distance estimates (e.g., based on RSSI measurements), vectors, degrees, orientation of the image capture device(s) 106 and/or the like.

In one example, image and LiDAR measurements taken by an image capture device 106 (and/or a sensor component as described herein) may be associated with the AoA and distance generated by any number of anchor system(s) 102. The accuracy of the location of the scan point may be improved when there are three anchor system(s) 102 or more (e.g., to assist in triangulation) that provide location information (e.g., AoA and distance measurements from each of the anchor system(s) 102 and the image capture device 106 at a particular scan point). A digital device (e.g., in the cloud or a local device) may use the location information associated with images and measurements captured at that scan point to assist with orientation, alignment, and stitching with other images and measurements captured at another scan point (e.g., by the same or different image capture device 106). It will be appreciated that location information associated with images and measurements captured at the other scan point (e.g., by the same or different set of anchor system(s) 102 that generated AoA and distance measurements relative to the first scan point) may be used in conjunction with location information associated with images and measurements captured at the first scan point to orient, align, and stitch the images and measurements captured at the two different scan points. The process of orienting, aligning, and stitching images using location information associated with different scan points may be used to create the 3D model or digital twin of the environment.

Similarly, images and/or measurements taken along the path (e.g., by a drone or robot including the image capture device 106), may be associated with location information such as vector, degree, and distance measurements between the device (e.g., the drone, robot, or image capture device 106) and any number of anchor system(s) 106 while the device is in motion along the path. As such, images and/or measurements captured by the device while in motion may be associated with different vector, degree, and distance measurements over time. In various embodiments, images and/or measurements may be taken over time. The time may be tracked and associated with when the images and/or measurements were captured. Similarly, the anchor system(s) 102 may generate a timestamp when generating/determining the vector, degree, and distance measurements. The tracked time by the device and timestamp from the anchor system(s) 102 may be used to associate images and measurements taken while in motion along the path by the image capture device 106 with location information provided by the anchor system(s) 102. Subsequently, the images and measurements taken while in motion along the path by the image capture device 106 may be oriented, aligned, and/or stitched with each other. Similarly, the images and measurements taken while in motion along the path by the image capture device 106 may be oriented, aligned, and/or stitched with images and measurements captured at one or more scan points (e.g., utilizing the location information associated with some images and measurements along the path as well as the location information associated with images and measurements taken at the scan point).

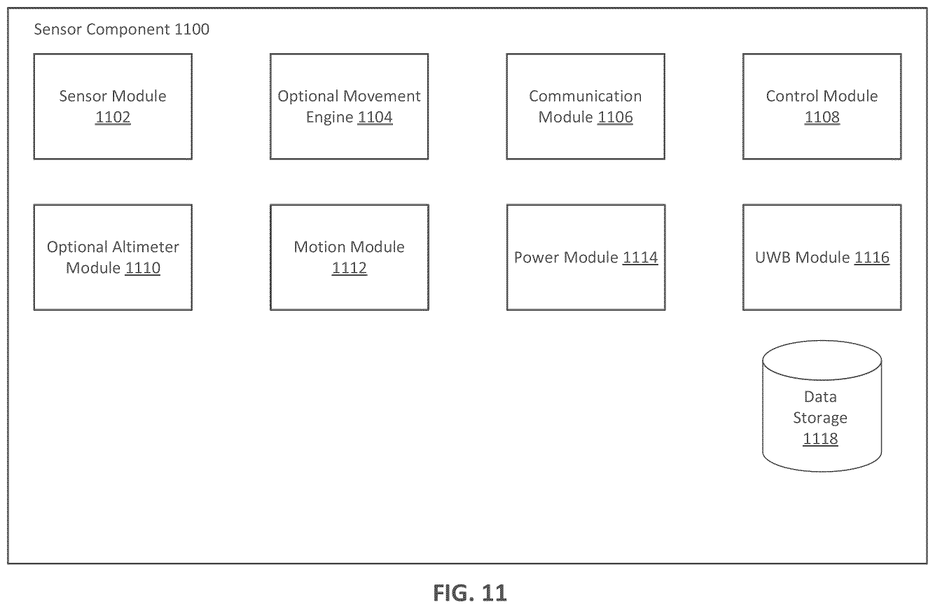

FIG. 11 is a box diagram example of a sensor component 1100 in some embodiments. The sensor component 1100 may include a sensor module 1102, an optional movement engine 1104, a communication module 1106, a control module 1108, an optional altimeter module 1110, a motion module 1112, a power module 1114, a UWB module 1116, and a data storage module 1118. It will be appreciated that the sensor component 1100 may be used in conjunction with one or more of the flowcharts discussed herein.

The sensor component 1100 may include any number of sensors configured to provide and/or receive energy for measuring a portion of the environment. In some embodiments, the sensor component 1100 is circular and the sensors are positioned radially (e.g., symmetrically radial) about the sensor component 1100 thereby enabling information about the environment to be obtained (e.g., signals received and measurements obtained) very quickly. In various embodiments, the sensor component 1100 may have sensors on one portion (e.g., one side) of the device. In this example, the sensor component 1100 may be motorized in that the sensor component may be configured to turn the sensors into different directions (e.g., 180 degrees to capture the front and then the back of the sensor component 1100) and measurements obtained.

The sensors may be any kind of sensors or any combination of different types of sensors. In some embodiments, the sensors include LiDAR sensors. The sensors, in some embodiments, may be iToF sensors that emit light (e.g., from LEDs) and measure the phase shift of the returning light, rather than directly measuring the time it takes for light to travel back and forth. This phase information is then used to calculate distances. In various embodiments, there may be pairs of sensors, including one sensor to emit energy (e.g., IR laser light) and another to detect reflected energy to generate measurements for depth determination. In some embodiments, one or more of the sensors may provide a range of 90-135 degree field of view vertically and/or horizontally relative to the environment.

In some embodiments, each sensor may have a field of view that may overlap (e.g., substantially or partially overlapping) with the field of view of at least one other sensor. Alternately, each sensor, or a subset of sensors, do not have a field of view that overlaps with another sensor. There may be sensors linearly positioned about the sensor component 1100. In some embodiments, there may be multiple sensors one above another to obtain a greater vertical field of view. It will be appreciated that fixing the sensors enables positioning the field of view of each sensor to improve coverage of a surrounding environment and/or assist in alignment and positioning of sensor measurements with the environment and/or images of the environment.

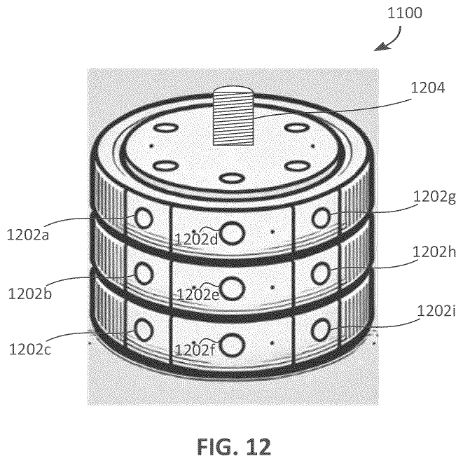

FIG. 12 depicts an example sensor component 1100 in some embodiments. In this example, the sensor component 1100 has a cylindrical shape and includes sensors 1202a-i, with three sensors stacked vertically from the base of the sensor component 1100 towards the top. It will be appreciated that there may be any number of sensors that may be positioned above or below another sensor. In some embodiments, there may be only one sensor without another sensor above or below.

While the sensor component 1100 is depicted as cylindrical in shape, it will be appreciated that the sensor component 1100 may be any shape.

The sensor component 1100 depicted in FIG. 12 may have a mount 1204 that enables one or more different digital devices to be coupled to the sensor component 1100. While the mount 1204 depicted in FIG. 12 is a screw-type mount, it will be appreciated that the mount 1204 may be or include any number of different types of mounting hardware including, for example, magnetic mount, brackets, space for sliding, clips, mounting bars, springs, capture members, hooks, claws, and/or the like. Similarly, the mount 1204 may be or include hardware to grab and retain another device the mount 1204 may be or include hardware to be grabbed or retained by the other device.

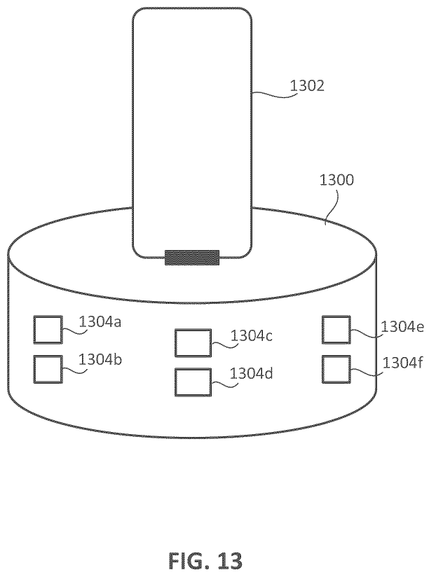

FIG. 13 depicts another sensor component 1300 coupled to a digital capture device 1302 in some embodiments. The sensor component 1300 may be another version of the sensor component 1100 (e.g., including all or some of the elements depicted in FIG. 11). The digital capture device may include, for example, a smart phone, camera (e.g., Matterport 360), or any other digital device. In this example, like the sensor component 1100, the sensor component 1300 has a cylindrical shape and includes sensors 1304a-f, with two stacked vertically from the base of the sensor component 1300 towards the top. In some embodiments, the stacked sensors are positioned around the sensor component 1300 such that the field of view of the depth sensors capture the environment around the sensor component 1300 (e.g., with no or little overlap between the view of one sensor and another adjacent center). For example, sensor 1304a may have a field of view that extends up to the field of view of sensor 1304c. In some embodiments, each pair of sensors (e.g., sensors 1304a and 1304b) includes one sensor (e.g., sensor 1304a) emitting energy and the other sensor (e.g., sensor 1304b) detecting reflected energy.

There may be any number of sensors positioned around the sensor component 1300. As discussed herein, in some embodiments, there may be a fixed number of sensors on one part of the sensor component 1300 (e.g., on one side) and all or part of the sensor component 1300 may optionally rotate (e.g., turned by a motor that is internal or external to the sensor component 1300) such that all or some of the sensors may rotate about the sensor component 1300 and take measurements at different positions (e.g., depth measurements are taken by a partial or full rotation of the sensors about the sensor component 1300).

It will be appreciated that there may be any number of sensors that may be positioned above or below another sensor. In some embodiments, there may be only one sensor without another sensor above or below.

While the sensor component 1300 is depicted as cylindrical in shape, it will be appreciated that the sensor component 1300 may be any shape.

Similar to the sensor component 1100 depicted in FIG. 12, in some embodiments, the sensor component 1300 may have a mount or a receiving aperture (e.g., orifice) that may enable the sensor component 1300 to couple to a digital device (e.g., digital capture device 1302 which may be or include an image capture device). The mount may be capable of mounting to the digital device in any number of ways (e.g., the mount may be screw-type, magnetic, or the like). In some embodiments, the sensor component 1300 may not have a mount. In some embodiments, the sensor component 1300 may include a motor for turning the mount and/or any digital device coupled to the mount such that the digital device may spin or turn in place.

In the example of sensor component 1300, the mount is a clip or jaws that may hold a part of the digital device. In some embodiments, the digital device may be placed within the clip or jaws in different positions. For example, the digital device may be positioned such that the image capture sensors of the digital device are aligned with the axis of rotation (e.g., the axis of rotation extending through the middle and out of the top of the sensor component 1300) to reduce or eliminate parallax effects (e.g., the mount may be moved to position the digital device along a no-parallax axis of rotation). For example, the sensor component 1300 or the top of the sensor component 1300 may rotate such that the rotating portion of the sensor component 1300 turns the image capture device. The image capture device may capture images about the space and then be turned to capture additional images.

In various embodiments, each sensor is a depth sensor, such as an OTOCAM501, capable of providing and/or receiving signals to determine depth. In some embodiments, the sensor component includes one or more processors (e.g., each one in communication with a different sensor) that is configured to generate a point cloud, IR frame, and/or depth frame based on information received by the sensors. In some embodiments, measurements are provided to one or more processors on the sensor component 1300, on an external digital device, and/or in the cloud (e.g., on a platform).

In some embodiments, two or more sensors may utilize stereo vision or structured light (e.g., with overlapping fields of view). In various embodiments, one or more sensors may use time-of-flight and/or DEPTHSENSE (or the like). The sensors of the sensor component 1300 may utilize backside illumination to utilize time-of-slight sensor with higher resolution.

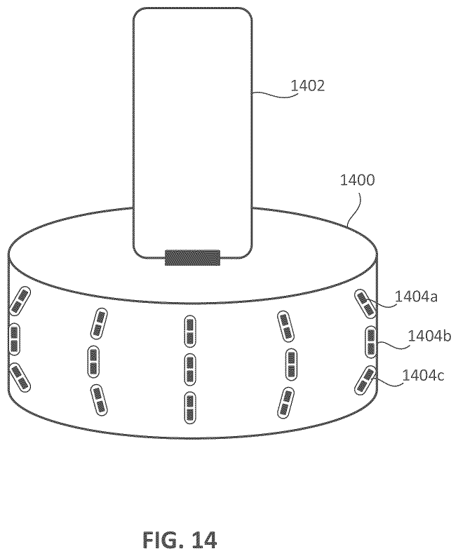

FIG. 14 depicts another sensor component 1400 coupled to a digital capture device 1402 in some embodiments. Like the sensor component 1400 depicted in FIG. 14, the sensor component 1400 may be another version of the sensor component 1100 (e.g., including all or some of the elements depicted in FIG. 11). In this example, each set of sensors includes three pairs of sensors positioned from top to bottom to enable a field of view from higher elevation to lower elevation about the sensor component 1400. Each set of sensors may include a pair of sensors positioned such that they have a different vertical field of view that may not overlap or only partially overlap with other sensors of that particular set.

By positioning each set of sensors in a fixed position and capable of covering a greater field of view at higher and lower elevations of the environment (e.g., different pairs of sensors pointed upwards and downwards relative to the environment), more of the environment may be captured. Similarly, by positioning and fixing sets of sensors (e.g., aligning sets of sensors in a column-like positions relative to each other), they may also cover more of the environment in less time (e.g., a large part of the environment may be captured simultaneously or near simultaneously). The fixed nature of the sensors further enable time to be saved in determining the position of measurements relative to the room, relative to other depth measurements, and/or relative to images taken of the environment which further improves the accuracy of 3D model creation and speed of 3D model creation.

In some embodiments, the sensor component 1400 includes sensors positioned around the sensor component 1400 such that depth information of the environment surrounding the sensor component 1400 may be captured simultaneously or near simultaneously and without moving the sensors and/or sensor component 1400. This greatly improves speed and accuracy. In one example, the user does not have to wait for alignment between scans of the environment. Further, due to the fixed nature of the sensors relative to each other and the number of sensors, alignment is far more accurate (e.g., there is no opportunity for alignment errors between sensor positions) and, as a result, rescanning to correct or improve accuracy is, in some embodiments, not necessary.

Further, regarding the sensor components depicted in the examples of FIGS. 12 and 13, by positioning each set of sensors in a fixed position and capable of covering a greater field of view more of the environment may be captured. Similarly, by positioning and fixing sets of sensors, they may also cover more of the environment in less time (e.g., a large part of the environment may be captured simultaneously or near simultaneously). The fixed nature of the sensors further enable time to be saved in determining the position of measurements relative to the room, relative to other depth measurements, and/or relative to images taken of the environment which further improves the accuracy of 3D model creation and speed of 3D model creation.

Returning to FIG. 11, the sensor component 1100 may include the optional movement engine 1104. As discussed herein, the sensor component 1100 may optionally include a motor configured to turn the sensor component 1100 or the sensors of the sensor component 1100 to face different directions. In this example, if there are not sufficiently positioned sensors to take sensor measurements around the sensor component 1100 simultaneously or near simultaneously, the sensor component 1100 may turn the sensors to different positions to obtain more information.

In the example of sensor component 1100, the motor may be configured to turn the sensors or the entire device. In some embodiments, the sensor component 1100 may include a mechanical or magnetic mount for holding an image capture device 106 (e.g., the Matterport 360). In some embodiments, the image capture device 106 takes images of the environment and the sensors take depth measurements. In some embodiments, when the sensor component 1100 turns about the vertical axis (e.g., an axis that extends through the center of the cylindrical shape), the mounting component may not turn or may counter-turn to enable the image capture device 106 to remain in place.

In some embodiments, the sensor component 1100 does not include any mounting components to couple with a digital device and the sensor component 1100 may operate to obtain additional information of the environment 104 separate from the image capture device 106.

In various embodiments, the sensor component 1100 includes a mount that enables the sensor component 1100 to be mounted on a pole, support, drone, and/or the like. In an example of the sensor component 1100 being circular or cylindrical, the sensor component 1100 may have a mount that is located on the bottom opposite the top of the sensor component 1100 (e.g., the top of the sensor component 1100 including, in this example, a second mount to couple the digital device). In one example, the sensor component 1100 may be mounted (e.g., via the mount) on the pole, support, drone, robot, or the like to position, stabilize, move, and/or elevate the sensor component 1100 before, during, or after sensor measurements are taken of an environment. In one example, the sensor component 1100 is elevated by a pole and positioned and/or stabilized to take additional images (e.g., via a mounted image capture device) and/or depth data captured at desired elevations.

The mount for coupling the sensor component 1100 to the pole, support, drone, robot, or the like may be or include any number of different types of mounting hardware including, for example, magnetic mount, brackets, space for sliding, clips, mounting bars, springs, capture members, hooks, claws, and/or the like. Similarly, the mount may be or include hardware to enable the pole, support, drone, robot, stabilizer, gimble, or the like to grab and retain the sensor component 1100.

In some embodiments, the sensor component 1100 includes a balancing sensor configured to take measurements to determine if the sensor component 1100 is level and/or stable. In various embodiments, the sensor component 1100 may provide a signal (e.g., via the communication module 1106) to indicate if the sensor component 1100 is level and/or stable. Further, in some embodiments, the sensor component 1100 may provide a signal to indicate what corrective action is necessary to level and/or stabilize the sensor component 1100. Additionally or alternatively, the sensor component 1100 may provide feedback on the sensor component 1100 itself (e.g., via an LED screen or lights) to indicate if the sensor component 1100 is level and/or stable.

The communication module 1106 enables the sensor component 1100 to communicate with another digital device (e.g., a smart phone and/or an image capture device 106). In some embodiments, the communication module 1106 may communicate with another digital device by Bluetooth, Zigbee, Wi-Fi, and/or any other communication protocol. In various embodiments, after measurements are taken, the communication module 1106 may provide measurements (e.g., processed measurements or raw data) to the smartphone and/or image capture device 106).

In some embodiments, the sensor component 1100 may include any number of antennas positioned at different fixed positions and/or angles from each other. The positions of the different antennas may be utilized to track AoA and/or the like to assist in determining the positions of the sensor component 1100 relative to the anchor systems, image capture devices, other sensor components, and/or the like as discussed herein.

The control module 1108 may enable control of the sensor component 1100 such as sensor control, obtaining measurements, controlling optional motion of the sensor component 1100, communicating measurement information to another digital device (e.g., the image capture device 106, smart phone, and/or anchor system 102).

In some embodiments, the sensor component 1100 may determine its position relative to the positional signals of the one or more anchor system(s) 102. In one example, the sensor component 1100 triangulates its position and determines signal strength of the different positional signals from the anchor system(s) 102. The position information may be associated with sensor measurements of the sensor component 1100 and provided to another digital device (e.g., smart phone) to be used in generation of the 3D model (e.g., for improved dimensional and positional accuracy). In one example, when the 3D model is generated, images, sensor measurements from the sensor component 1100 and/or depth sensor information may be used based on the position of the device that captured the information (e.g., relative to the positional signals of the anchor system(s)) to enable improved accuracy.

The optional altimeter module 1110 may assist in determining the altitude of the sensor component 1100. In some embodiments, the sensor component 1100 may be moved and the optional altimeter module 210 may assist in determining if the sensor component 1100 changed height (e.g., the sensor component 1100 was moved upstairs to capture another floor, the sensor component 1100 is mounted on a telescoping pole, the sensor component 1100 is mounted on a drone, and/or the like).

The motion module 1112 may assist in determining if the sensor component 1100 is moved or is in motion. In various embodiments, the sensor component 1100 may determine its location relative to one or more other anchor system(s) 102 (e.g., utilizing the positioning signals of the other anchor system(s) 102). If the sensor component 1100 is moved, the motion module 1112 may assist in determining when the sensor component 1100 is in motion and/or becomes stationary. While in motion, in some embodiments, the sensor component 1100 (or the image capture device 106 or the smart phone) may determine the location of the sensor component 1100 while in motion (e.g., relative to the other anchor system(s) 102). In various embodiments, once the sensor component 1100 becomes stationary again, the sensor component 1100 may determine its new position, altitude, and the like relative to the other anchor system(s) 102 and relative to where the sensor component 1100 used to be (e.g., thereby extending the localized coordinate reference system that may be used by one or more image capture device 106 to determine position).

In some embodiments, the motion module 1112 may track the position of one or more sensor components 1100 when they are in motion and/or track when the one or more sensor components 1100 become stationary after moving.

The power module 1114 is any component or device that may provide power to the sensor component 1100. In some embodiments, the power module 214 may include a battery (e.g., alkaline batteries, a lithium battery, or a polymer battery, or the like). In various embodiments, the power module 1114 may be powered over a cable (e.g., receiving power via an outlet or other power source).

The optional data storage 1118 is any data storage and may include firmware to operate the sensor component 1100, store positional information of the sensor component 1100 relative to anchor system(s) 102, store orientation information of the sensor component 1100, store orientation information of sensor component 1100, store tracking data of movement or new positions of the anchor system 102 and/or the image capture device(s) 102, height information, and/or the like.

In various embodiments, the sensor component 1100 may include a GPS device (e.g., a GPS module) capable of determining a location relative to a GPS signal. In some embodiments, if satellite information is unavailable (e.g., blocked), then the sensor component 1100 may not utilize GPS coordinates (e.g., the local coordinate system that may be established by one or more sensor components 1100 may not be associated with geocoordinates from the GPS device. If there is a GPS device in one or more sensor component 1100 or the image capture device 106, the local coordinate system established by the one or more anchor system(s)) 102 may be associated with geocoordinates from the GPS device.

The UWB module 1116 may include a positional antenna and function as an anchor system 102. For example, the sensor component 1100 may provide positional signals to enable localization of anchor system(s) 102, image capture device(s) 106, and/or other digital devices. Although this module is referred to as a “UWB” module, the sensor component 1100 may provide positional signals using any kind of protocol and is not limited to UWB.

The optional data storage 1118 is any data storage and may include firmware to operate the sensor component 1100, store positional information of the sensor component 1100 relative to anchor system(s) 102, store orientation information of the sensor component 1100, store tracking data of movement or new positions of the sensor component 1100, height information, and/or the like.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times.

Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or. ” Rather, “or” is to be understood as including “and/or. ” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, although auditing of revenue associated with content may be described, the systems and methods described herein may be applicable to auditing of revenue from any source.

Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving a set of images associated with a real-world environment;
receiving first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images; and
generating a navigational model of the real-world environment using the first positional measurements associated with different subsets of the set of images to increase accuracy of the model of the real-world environment.

2. The non-transitory computer-readable medium of claim 1, wherein the one or more anchor systems provide UWB signals as the first positioning signals.

3. The non-transitory computer-readable medium of claim 1, wherein the one or more anchor systems include at least three anchor systems that provide the first positioning signals.

4. The non-transitory computer-readable medium of claim 1, wherein the set of images includes a second subset of images captured by the image capture device at a second location, the second subset of images being taken by the image capture device of the real-world environment, the first subset of images being a different portion of the real-world environment relative to the second subset of images, and generating the navigational model comprises using the first positional measurements associated with both the first subset of images and the second subset of images.

5. The non-transitory computer-readable medium of claim 4, further comprising receiving second positional measurements generated at or near a time that the second subset of the set of images are captured by the image capture device at the second location, the second positional measurements indicating a second position relative to positioning signals provided by the one or more anchor systems.

6. The non-transitory computer-readable medium of claim 1, wherein the positional measurements are based on positioning signals received from the image captured device by the one or more anchor systems, each of the one or more anchor system determining an angle of arrival based on the positioning signals.

7. The non-transitory computer-readable medium of claim 6, wherein for each anchor system of the one or more anchor systems, the angle of arrival is based on a position of a plurality of antennas that receive the positioning signals, each anchor system including a different plurality of antennas in a fixed position relative to each other for thar particular anchor system.

8. The non-transitory computer-readable medium of claim 5, wherein the positional measurements are based on positioning signals received from the image captured device by the one or more anchor systems, each of the one or more anchor system determining a vector directed to the image capture device based on the positioning signals.

9. The non-transitory computer-readable medium of claim 1, wherein the positional measurements are based on positioning signals received from the anchor systems by the image capture device, each of the one or more anchor system determining an angle of arrival based on the positioning signals.

10. A method comprising:
receiving a set of images associated with a real-world environment;
receiving first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images; and
generating a navigational model of the real-world environment using the first positional measurements associated with different subsets of the set of images to increase accuracy of the model of the real-world environment.

11. The method of claim 10, wherein the one or more anchor systems provide UWB signals as the first positioning signals.

12. The method of claim 10, wherein the one or more anchor systems include at least three anchor systems that provide the first positioning signals.

13. The method of claim 10, wherein the set of images includes a second subset of images captured by the image capture device at a second location, the second subset of images being taken by the image capture device of the real-world environment, the first subset of images being a different portion of the real-world environment relative to the second subset of images, and generating the navigational model comprises using the first positional measurements associated with both the first subset of images and the second subset of images.

14. The method of claim 13, further comprising receiving second positional measurements generated at or near a time that the second subset of the set of images are captured by the image capture device at the second location, the second positional measurements indicating a second position relative to positioning signals provided by the one or more anchor systems.

15. The method of claim 10, wherein the positional measurements are based on positioning signals received from the image captured device by the one or more anchor systems, each of the one or more anchor system determining an angle of arrival based on the positioning signals.

16. The method of claim 15, wherein for each anchor system of the one or more anchor systems, the angle of arrival is based on a position of a plurality of antennas that receive the positioning signals, each anchor system including a different plurality of antennas in a fixed position relative to each other for thar particular anchor system.

17. The method of claim 14, wherein the positional measurements are based on positioning signals received from the image captured device by the one or more anchor systems, each of the one or more anchor system determining a vector directed to the image capture device based on the positioning signals.

18. The method of claim 10, wherein the positional measurements are based on positioning signals received from the anchor systems by the image capture device, each of the one or more anchor system determining an angle of arrival based on the positioning signals.

19. A system comprising:
at least one processor; and
memory, the memory containing instructions to control the at least one processor to:
receive a set of images associated with a real-world environment;
receive first positional measurements generated at or near a time that a first subset of the set of images are captured by an image capture device at a first location, the first positional measurements indicating a position relative to positioning signals provided by one or more anchor systems that are positioned in different locations in the real-world environment, the one or more anchor systems being separate and external from the image capture device that captured at least the subset of images; and
generate a navigational model of the real-world environment using the first positional measurements associated with different subsets of the set of images to increase accuracy of the model of the real-world environment.
